(19) United States
(12) Patent Application Publication
(10) Pub. No.: US 2013/0079408 A1
(43) Pub. Date: Mar. 28, 2013

(54) PERACID AND 2-HYDROXY ORGANIC ACID COMPOSITIONS AND METHODS FOR TREATING ITEMS

(71) Applicant: Kai Lai Grace Ho, Salinas, CA (US)

(72) Inventor: Kai Lai Grace Ho, Salinas, CA (US)

(73) Assignee: Fresh Express Incorporated, Salinas, CA (US)

(21) Appl. No.: 13/528,734

(22) Filed: Jun. 20, 2012

Related U.S. Application Data
(63) Continuation of application No. PCT/US2010/061354, filed on Dec. 20, 2010.
(60) Provisional application No. 61/288,751, filed on Dec. 21, 2009.

(51) Int. Cl. A01N 37/36; A01N 37/16

(52) U.S. Cl. CPC A01N 37/36; A01N 37/16
USPC 514/557

(57) ABSTRACT

Methods and compositions for treating items to control microorganisms are provided. The method treats produce by contacting the surface of the item with an aqueous composition comprising i) an organic peracid of the formula RC(O)OOH wherein R is methyl, ethyl, n-propyl, or s-propyl; ii) a 2-hydroxy organic acid selected from tartaric acid, citric acid, malic acid, mandelic acid, and lactic acid; and iii) water; wherein the aqueous composition has a pH from 2.5 to 6.0.

### BACKGROUND OF THE INVENTION

Safe and reliable means of removing microorganisms from the environment is a growing public health and agricultural concern. Existing methods for removing or reducing environmental microorganisms do not adequately control microorganisms that have the potential to cause disease or spoilage. Accordingly, there is a large need for new methods and compositions that can greatly reduce the presence of microorganisms in the environment.

This invention provides compositions and methods that meet these needs.

### BRIEF SUMMARY OF THE INVENTION

The invention relates to the discovery that an aqueous solution comprising peroxyacetic acid, lactic acid, and (optionally) sodium lauryl sulfate or another surfactant is surprisingly effective in reducing microbial contamination on the surfaces of items. The combination of the ingredients is much more effective at reducing attached microbes on an item than any one of the ingredients acting alone. Accordingly, the invention provides compositions and methods useful in contact surface sanitation. Sanitizing or disinfecting the surfaces control or reduces the presence of unwanted microorganisms on the surfaces of any fomite or other items. In a first aspect the invention provides methods of sanitizing or disinfecting surfaces by contacting the surface of an item with a composition according to the invention.

The compositions according to the invention are aqueous compositions having a pH of 2.5 to 6.0 and comprising i) an organic peracid of the formula RC(O)OOH wherein R is methyl, ethyl, n-propyl, or s-propyl; ii) a 2-hydroxy organic acid selected from tartaric acid, citric acid, malic acid, mandelic acid, and lactic acid; iii) water; and optionally iv), an anionic surfactant. In preferred embodiments, the peracid is peroxyacetic acid (also known as peracetic acid or acetyl hydroperoxide), the organic acid is lactic acid (also known as 2-hydroxypropionic acid), and if present, the preferred anionic surfactant is sodium lauryl sulfate. Because aqueous sanitizing solutions of peracids may exist in equilibrium with, or be formed from concentrated solutions of, hydrogen peroxide, their corresponding acid, and water, the aqueous sanitizing compositions may also contain hydrogen peroxide and the corresponding acid (e.g., acetic acid in the case of peroxyacetic acid). The sanitizing compositions may be provided as concentrates or in ready-to-use aqueous formulations. The compositions may also be provided as part of a kit for use in sanitizing items.

In some embodiments the items whose surfaces are sanitized or disinfected have a hard or soft surface which are at risk of contamination from microorganisms.

In other embodiments, the surfaces belong to articles found in day care environments, private homes, communal or institutional settings (e.g., prisons, shelters, nursing homes, assisted living facilities, dormitories, hospitals, medical or dental clinics, day care facilities, the hospitality industry), public transportation, offices, and industry. In particular embodiments, the articles are those which are particular likely to become contaminated with unwanted or disease causing microorganisms or in need of extra sanitation (e.g, children's toys, bathroom articles and surfaces, kitchen surfaces and utensils, rental equipment and clothing, recycled or returned goods or clothing). Accordingly, still, in some embodiments, the surface is a surface found in a food processing environment (equipment and tools, e.g., harvesting, cutting boards, cutting knives and blades), or a surface found in the health care industry. In other embodiments, the surface is that of an instrument (e.g. a medical or dental instrument). The surfaces can also be that of clothing, upholstery, seats, sinks, bathtubs, counters, tables, or other furniture.

In some embodiments, the compositions according to the invention are used to treat water contact surfaces to prevent or hinder the biofilm formation. For instance, faucets and showers in hospitals and other health care settings can be contacted with a composition according to the invention to prevent biofilms from forming. Such bioflims can cause respiratory or skin infections, including wound infections, if not prevented.

In another aspect, the invention provides the compositions according to the invention in a packaging or format suitable for use in a method according to the invention.

### BRIEF DESCRIPTION OF THE DRAWINGS

FIG. 1 is a comparison of five treatments, in left to right order: a) chlorinated water: 50-70 ppm active chlorine at pH 6.5; b) CS: a commercial antimicrobial produce cleaner with major active ingredients as citric acid plus surfactants; c) Peroxyacetic acid: 70 to 80 ppm peroxyacetic acid+0.01% surfactant; d) lactic acid solution: 0.9 to 1.2% lactic acid+0.01% surfactant; and e) FE: 70 to 80 ppm peroxyacetic acid+0.9 to 1.2% lactic acid+0.01% surfactant) on flume-water suspended cells challenge test. The surfactant used was sodium lauryl sulfate.

FIG. 2 is a comparison of each of the five treatments of FIG. 1 in a leaf-attached cell challenge test.

FIG. 3 is a comparison of the ability of chlorinated water and an aqueous solution according to the invention (FE: peroxyacetic acid, lactic acid and sodium lauryl sulfate) to reduce the decay of treated produce.

FIG. 4 is a comparison of the ability of chlorinated water and an aqueous solution according to the invention (FE: peroxyacetic acid, lactic acid and sodium lauryl sulfate) to reduce off-odor in treated produce.

FIG. 5 is a comparison of the ability of chlorinated water and an aqueous solution according to the invention (peroxyacetic acid, lactic acid and sodium lauryl sulfate) to reduce the decay of Spring Mix with a low-moisture content.

FIG. 6 is a comparison of the ability of treatment with chlorinated water or an aqueous solution according to the invention (peroxyacetic acid, lactic acid and sodium lauryl sulfate) to reduce off-odor in a Spring Mix with a low-moisture content.

FIG. 7 is a comparison of the ability of chlorinated water and an aqueous solution according to the invention (peroxyacetic acid, lactic acid and sodium lauryl sulfate) to inhibit the growth of indigenous microorganisms in a Spring Mix with a low-moisture content.

FIG. 8 is a comparison of the ability of chlorinated water and an aqueous solution according to the invention (peroxyacetic acid, lactic acid and sodium lauryl sulfate) to inhibit spoilage in a Spring Mix with a low-moisture content.

FIG. 9 is a comparison of the ability of chlorinated water and an aqueous solution according to the invention (peroxyacetic acid, lactic acid and sodium lauryl sulfate) to reduce the decay of Spring Mix with a high-moisture content.

FIG. 10 is a comparison of the ability of treatment with chlorinated water or an aqueous solution according to the invention (peroxyacetic acid, lactic acid and sodium lauryl sulfate) to reduce off-odor in a Spring Mix with a high-moisture content.

FIG. 11 is a comparison of the ability of chlorinated water and an aqueous solution according to the invention (peroxyacetic acid, lactic acid and sodium lauryl sulfate) to inhibit growth of indigenous microorganisms in a Spring Mix with a high-moisture content.

FIG. 12 is a comparison of the ability of chlorinated water and an aqueous solution according to the invention (peroxyacetic acid, lactic acid and sodium lauryl sulfate) to inhibit spoilage in a Spring Mix with a high-moisture content.

FIG. 13 is a comparison of the ability of chlorinated water and an aqueous solution according to the invention (peroxyacetic acid, lactic acid and sodium lauryl sulfate) to reduce the decay of spinach.

FIG. 14 is a comparison of the ability of treatment with chlorinated water or an aqueous solution according to the invention (peroxyacetic acid, lactic acid and sodium lauryl sulfate) to reduce off-odor in spinach.

FIG. 15 is a comparison of the ability of chlorinated water and an aqueous solution according to the invention (peroxyacetic acid, lactic acid and sodium lauryl sulfate) to inhibit the growth of indigenous microorganisms in spinach with a high-moisture content.

FIG. 16 is a comparison of the ability of chlorinated water and an aqueous solution according to the invention (peroxyacetic acid, lactic acid and sodium lauryl sulfate) to inhibit spoilage microorganisms in spinach.

### DETAILED DESCRIPTION OF THE INVENTION

The invention relates to the discovery that an aqueous composition comprising peroxyacetic acid, lactic acid is surprisingly effective in reducing microbial contamination on the surfaces of items. The combination of the ingredients is much more effective at reducing attached microbes on an item than any one of the ingredients acting alone.

Peroxyacetic acid antimicrobial activity relies on its high oxidizing potential. The mechanism of oxidation is the transfer of electrons, therefore the stronger the oxidizer, the faster the electrons are being transferred to the microorganism and the faster the microorganism is inactivated or killed. Therefore based on the table below peroxyacetic acid has a higher oxidation potential than chlorine sanitizers but less than that of ozone.

### Oxidation Capacity of Selected Sanitizers

| Sanitizer | eV* |
|---|---|
| Ozone | 2.07 |
| Peroxyacetic acid | 1.81 |
| Chlorine Dioxide | 1.57 |
| Sodium hypochlorite (Chlorine bleach) | 1.36 |

*electron-Volts

As diffusion of the molecule is slower than its half-life, peroxyacetic will react with any oxidizable compounds in its vicinity. It can damage virtually all types of macromolecules associated with a microorganism; for e.g. carbohydrates, nucleic acids (mutations), lipids (lipid peroxidation) and amino acids (e.g. conversion of Phe to m-Tyr and o-Tyr), and ultimately lysis the cell. Conventionally 2-hydroxy organic acids such as lactic acid that possess the chemical properties of oxidizable organic compounds would be taught away from being used together with a strong oxidizer, particularly with reference to peracids. Hence, it is particularly surprising to combine the peracetic acid and lactic acid in this invention and shown that the two compounds have synergistic effects rather than one counteracting against the other.

### DEFINITIONS

It must be noted that, as used in this specification and the appended claims, the singular forms “a,” “an” and “the” include plural referents unless the content clearly dictates otherwise. Thus, for example, reference to a “surfactant” without more includes two or more such surfactants.

Unless defined otherwise, all technical and scientific terms used herein have the same meaning as commonly understood by one of ordinary skill in the art to which the invention pertains. All ranges are inclusive of the end values.

With reference to the aqueous compositions and methods of the invention, “peracid” and “organic peracid” refer to compounds of the structure RC(O)OOH in which R is an aliphatic group having from 1 to 3 carbon atoms. R may be methyl, ethyl, n-propyl, or s-propyl. A particularly preferred peracid is peracetic acid/peroxyacetic acid/PAN(CH₃C(O)OOH). Mixtures of the above organic peracids may be used.

In aqueous solutions, organic peracids exist in a chemical equilibrium with hydrogen peroxide and accordingly can be formed from the corresponding organic acids and hydrogen peroxide in the reaction:

RCOOH+H₂O₂ [symbol] RC(O)OOH+H₂O

The equilibrium concentration of each reactant can be calculated from the equilibrium equation:

([RCOOOH][H₂O])/([RCOOH][H₂O₂])=Kₐₚ (Eq. 1)

wherein: [RCOOOH] is the concentration of peracid in mole/L; [H₂O] is the concentration of water in mole/L; [RCOOH] is the concentration of organic acid in mole/L; and [H₂O₂] is the concentration of hydrogen peroxide in mole/L; and Kₐₚ is the apparent equilibrium constant for the peracid equilibrium reaction (Equation I).

The apparent equilibrium constant, Kₐₚ, varies with both the peracid chosen and with temperature. Equilibrium constants for peracid formation can be found in D. Swern, ed., Organic Peroxides, Vol. 1, Wiley-Interscience, New York, 1970. At a temperature of 40° C., the apparent equilibrium constant for peroxyacetic acid is about 2.21. In accordance with this equilibrium reaction aqueous organic peracid compositions comprise hydrogen peroxide and the corresponding organic acid in addition to the organic peracid.

When diluted, a relatively long period of time may lapse before a new equilibrium is achieved. For instance, equilibrium solutions that comprise about 5% peroxyacetic acid typically comprise about 22% hydrogen peroxide. Equilibrium solutions that comprise about 15% peroxyacetic acid typically comprise about 10% hydrogen peroxide. When these equilibrium solutions are diluted to solutions that comprise about 50 ppm of peroxyacetic acid, the solution produced by dilution of the 5% peroxyacetic acid solution comprises about 220 ppm of hydrogen peroxide, and the solution produced by dilution of 15% solution comprises about 33 ppm of hydrogen peroxide. Accordingly, in some embodiments, the sanitizing composition is provided as a concentrate which is diluted to the desired peracid concentration with water or with an aqueous composition comprising other components of the sanitizing composition according to the invention just prior to use. In some embodiments, the sanitizing compositions are provided as concentrates which are diluted just prior to use.

Peracids are readily commercially available in accordance with the above equilibrium. Peroxyacetic acid (CAS No. 79-21-0) is readily commercially available, for instance, as aqueous solution comprising peroxyacetic acid (35%), hydrogen peroxide (6.5%), acetic acid 64-19-7 (40%), sulfuric acid (about 1%) and water (about 17%) (all units w/w).

The 2-hydroxy organic acid is selected from tartaric acid, citric acid, malic acid, mandelic acid, and lactic acid. The predominant biological optical isomers are preferred. The 2-hydroxy organic acid can also be provided as the racemate, as well as any of its optically pure isomers. In some embodiments, the (+) enantiomer is preferred (e.g., L-lactic acid, L(+)-Lactic acid). A preferred organic acid is L(+)-Lactic acid.

As used herein, the term “sanitize” or “disinfect” shall mean the reduction of viable microorganisms on surfaces with the exception of bacterial endospores. In some embodiments, the reduction is by at least 99.9%, 99.99%, 99.999% (e.g., by 3, 4, or 5 log units, respectively) or at least by 3, 4, 5, 6, 7, 8, or log units as measured before and after contact with the sanitizing compositions according to the invention. In some embodiments, the sanitized surfaces have levels of pathogenic microorganisms considered safe according to any applicable public health ordinance or below thresholds thought to pose risk of infection or disease. Accordingly, a surface need not have complete elimination or destruction of all forms of microbial life to be sanitized. The reduction may be by physical removal, or toxicity to the microorganism leading to the destruction or inhibition of the growth of the microorganism.

The term “item” refers to something material and is tangible. “Items” include surfaces. These surfaces can be hard surfaces (glass, ceramic, metal, rock, wood, and polymer surfaces), soft surfaces (e.g., elastomeric or plastic surfaces, fabric surfaces). Accordingly, surfaces may belong to woven or non-woven materials. Surfaces and articles employed in the health care, medical, dental, institutional, school, office, sanitation, home, hospitality and industrial sectors are contemplated. A surface can be that of an instrument, device, apparatus, tool, cart, furniture, structure, or building. Examples of surfaces in the health care environment, for instance, include surfaces of medical or dental instruments, of medical or dental devices, of electronic machines employed for monitoring patient health, and of floors, walls, ceilings, or fixtures of structures in which the health care occurs. Health care surfaces are found in hospital, surgical, assisted living, nursing care, infirmity, birthing, and clinical diagnosis rooms. Patient-care equipment (such as respirators, diagnostic equipment, shunts, body scopes, wheel chairs, beds, etc.), or surgical and diagnostic equipment and their surfaces are also contemplated. Items requiring sanitation between uses are also contemplated.

“Surfaces” can be hard (such as walls, floors, bed-pans, etc.), or soft (e.g., woven and non-woven surfaces (such as surgical garments, draperies, bed linens, bandages, etc.). Health care surfaces include articles and surfaces employed in human health care activities.

An “instrument” references medical or dental instruments or tools that can benefit from sanitizing. Instruments include “medical or dental instruments, devices, apparatus, appliances, and equipment.” Instruments and tools include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, arthoscopes and related equipment.

In some further embodiments in any of the aspects and uses of the invention, there is a proviso that the item is not food, produce, a packaged food product, and/or an item which present in a food processing environment, or an item which is to be sanitized upon, before or after having come into contact with food. In some embodiments, there is al proviso further that the surface and/or item is not present or employed in the agricultural or veterinary setting.

The term “essentially free” means that the referenced compound or substance is present in the composition at a level less than about 300, preferably less than about 150 and more preferably less than about 50 and most preferably less than about 10 ppm or even 1 ppm by weight.

### Compositions of the Invention

Accordingly, in a first aspect, the invention provides an aqueous composition comprising 1) an organic peracid of the formula RC(O)OOH wherein R is methyl, ethyl, n-propyl, or s-propyl; ii) a 2-hydroxy organic acid selected from tartaric acid, citric acid, malic acid, mandelic acid, and lactic acid; and iii) water In some embodiments an anionic surfactant is also present. Preferably, the aqueous composition has a pH from 2.5 to 6.0. In some embodiments, the pH is from 2.5 to 3.5, 2.5 to 4.0, 2.7 to 3.5, 2.5 to 5.0, 3.0 to 4.0, 3.0 to 5.0, 3.0 to 6.0, or from 3.5 to 4.5.

Suitable 2-hydroxy organic acids for use in the aqueous compositions of the invention are tartaric acid, citric acid, malic acid, mandelic acid, and lactic acid (i.e., 2-hydroxypropanoic acid). An exemplary 2-hydroxy organic acid is lactic acid. A combination of two or more of any of the above 2-hydroxy organic acids may be used (e.g., lactic acid+citric acid; lactic acid+tartaric acid; lactic acid+malic acid; lactic acid+mandelic acid;).

A sanitizing composition according to the invention accordingly comprises i) an organic peracid of the formula RC(O)OOH wherein R is methyl, ethyl, n-propyl, or s-propyl; ii) a 2-hydroxy organic acid selected from tartaric acid, citric acid, malic acid, mandelic acid, and lactic acid; iii) water and a pH from 2.5 to 7.8, inclusive, wherein the concentration of peracid is from 40 to 250 ppm (w/w) inclusive, and the concentration of the 2-hydroxy organic acid is from 0.1 to 1% (w/w), inclusive. In further embodiments of any of the above, the principal component by weight of the composition is water. In some embodiments, the composition according to the invention is at least 50%, 60%, 70%, 80%, 90%, 95%, 98% or 99% water by weight.

In some embodiments, the peracid is peroxyacetic acid, the organic acid is lactic acid, and the optional anionic surfactant is sodium lauryl sulfate. In other embodiments, the concentration of peracid acid in the composition is from 3 to 100 ppm (w/w), the concentration of 2-hydroxy organic acid in the composition is from 0.1% to 2% (w/w); and the pH is between 2.5 and 5.0. In a still further embodiment, the concentration of peracid is 5 to 100 ppm (w/w), the concentration of 2-hydroxy organic acid is 0.1 to 2% (w/w).

In an additional embodiment, the aqueous composition of the invention, has a concentration of peracid in the composition from about 60 to 80 ppm (w/w), a concentration of 2-hydroxy organic acid in the composition of from about 0.2% to 1.25% (w/w); and a pH between about 2.8 to 4.2 or 3.8 and 4.2, inclusive.

In some embodiments, the concentration of the peracid in the composition can be from 3 to 100 ppm (w/w), the concentration of 2-hydroxy organic acid in the composition from 0.1% to 2% (w/w); and the pH is between 2.5 and 5.0. In a still further embodiment, the concentration of peracid is 50 to 100 ppm (w/w) and the concentration of 2-hydroxy organic acid is 0.1 to 1% (w/w). In further embodiments, the peracid is peroxyacetic acid and the 2-hydroxy organic acid is lactic acid (e.g., L(+)-lactic acid). In still further embodiments, the concentration of the peracetic acid is 60 to 90 ppm or 70 to 80 ppm. In still further embodiments of such, the concentration of the lactic acid is 0.1 to 0.8% or 0.2 to 0.4% (w/w).

In a particularly preferred embodiment, the invention provides a composition comprising, or consisting essentially of, an aqueous composition of peroxyacetic acid and lactic acid (e.g., L-(+)-Lactic acid) at a pH of from about 2.5 to 6.0, and more preferably at a pH between 2.8 to 4.2 or 3.8 to 4.2, inclusive, wherein the composition further comprises hydrogen peroxide and acetic acid and the composition is substantially free of any surfactant. In some embodiments, the aqueous composition is substantially free of any isomer of lactic acid other than L-(+)-Lactic acid. In further embodiments of any of the above, the concentration of peracid (e.g., peroxyacetic acid) in the composition is from 30 to 300 ppm (w/w), 60 to 80 ppm (w/w), 50 to 200 ppm (w/w); 60 to 160 ppm (w/w), 120 to 160 ppm (w/w), or 140 to 160 ppm (w/w); and the concentration of 2-hydroxy-organic acid (e.g., lactic acid) in the composition is selected from 0.1% to 5% (w/w), 0.1% to 2%, 0.2% to 1%, 0.2% to 0.6%, or 0.1% to 0.5%, or about 2%, 3%, or 4%; and the pH is from between 2.5 and 6.0, 2.5 to 5.0, 2.8 and 3.2, 2.5 and 3.5, or 2.6 and 3.2. In other embodiments of the above the composition is for contacting the item to be sanitized from 10, 20 or 30 seconds to 2 minutes or about 10, 20, 30 or 40 secs. In further embodiments, the concentration of peracid acid is from 30 to 100 ppm (w/w), and the concentration of the 2-hydroxy organic acid is from 0.3 to 2.0% (w/w). In a particularly preferred embodiment, the concentration of peracid is 70 to 80 ppm (w/w), and the concentration of the 2-hydroxy organic acid is from 0.2 to 0.4% (w/w). In other embodiments of any of the above, the composition is at a temperature of 35° F. to 45° F. or at ambient temperature. These aqueous compositions can be free or substantially free of surfactants including any or all of nonionic surfactants, cationic surfactants or anionic surfactants. Generally, low levels of hydrogen peroxide from 1 to 20 ppm, 5 to 15 ppm, or 7 to 12 ppm may be present in the composition. In some embodiments, any peracid of the 2-hydroxy organic acid formed from hydrogen peroxide or present in the aqueous composition can be present in an amount which is less than 1/10^{th}, ⅕^{th}, 1/20^{th}, or 1/50^{th} the amount of the corresponding 2-hydroxyorganic acid in the composition. In preferred embodiment of the above, the peracid is peroxyacetic acid and the 2-hydroxyorganic acid is selected from one or more of tartaric acid, citric acid, malic acid, mandelic acid, and lactic acid. In a particularly preferred embodiment, of any of the above, the 2-hydroxy organic acid is lactic acid. In some embodiments of any of the above, the composition is an aqueous solution.

A catalyst, added to accelerate the rate at which the organic peracid reaches equilibrium, may optionally also be present in the composition according to the invention. Typical catalysts are strong acids, such as, sulfuric acid, sulfonic acids, phosphoric, and phosphonic acids. When the peracid composition is diluted to produce the desired peracid level, the catalyst may also be diluted. The presence of low levels of sulfuric acid, for example concentrations in the range of about 1 ppm to about 50 ppm, does not adversely affect the properties of the sanitizer composition.

Optionally, any of the compositions of the invention may further comprise an agent to reduce or suppress sudsing or foaming of the composition during use or contact with the item. The compositions according to the invention may also be essentially free of any nonionic, anionic, and/or cationic surfactant and/or also be essentially free of any thickening agent.

The compositions according to the invention may also comprise a colorant to facilitate detection of the composition on the item.

If anionic surfactants are to be added to the aqueous compositions of the invention, in some embodiments, they may be selected from food-safe or cosmetic-safe materials or laundry safe materials known in the art, C₆₋₁₈ alkyl sulfates and/or sulfonates (e.g., sodium or potassium lauryl sulfate) and mixtures thereof. The alkyl sulfates are preferred, for antimicrobial effectiveness and palatability, especially as the sodium and/or potassium salts. Sodium dodecyl sulfate, or sodium lauryl sulfate, is a particularly preferred anionic surfactant.

In some embodiments, the composition comprises an amine oxide at a mole ratio of amine oxide to peroxycarboxylic acid of 1 or more. Many peroxycarboxylic acid composition exhibit a sharp, annoying, or otherwise unacceptable odor. Such an unacceptable odor can be reduced by adding an amine oxide to the peroxycarboxylic acid. The peroxycarboxylic acid can be made in the presence of the amine oxide, or the amine oxide can be added after forming the peroxycarboxylic acid. In an embodiment, the amine oxide can be employed in food products or for cleaning or sanitizing food processing equipment or materials. In an embodiment, the amine oxide can be employed in a health-care environment. In an embodiment, the amine oxide is non-toxic. In an embodiment, the amine oxide can be employed according to guidelines from government agencies, such as the Food and Drug Administration, without adverse labeling requirements, such as labeling with a skull and cross bones or the like. Preferred amine oxides include octyl amine oxide (e.g., octyldimethylamine oxide), lauryldimethyl amine oxide, and the like. Alternatively, the amine oxide can be applied separately to an item previously treated with a composition of the invention. In such embodiments, the amine oxide is preferably in an aqueous composition.

The amine oxide is typically present in a quantity that effectively reduces odor of the peroxycarboxylic acid. Suitable levels of amine oxide include a mole ratio of amine oxide to peroxycarboxylic acid of 1 or more. In an embodiment, the mole ratio is greater than or equal to 2. In an embodiment, the mole ratio is greater than or equal to 3. In an embodiment, the mole ratio is 2 to 5. In an embodiment, the mole ratio is 3 to 5. Octyl dimethyl amine oxide has a molecular weight of about 3 (e.g. 2.7) times as great as peroxyacetic acid, and applicable weight ratios can be calculated on such a basis (see, U.S. Pat. No. 7,622,606, issued Nov. 24, 2009, which is incorporated by reference with respect to suitable amine oxides for this purpose).

Exemplary amine oxides are of the formula

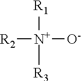

wherein R₁, R₂, and R₃ are independently selected from saturated or unsaturated and straight or branched alkyl groups having from 1-18 carbons and aromatic groups, etc. and which can optionally contain O, N or P as a heteroatom or polyalkoxy groups. Examples of amine oxides include, but are not limited to: alkyldimethylamine oxide, dialkylmethylamine oxide, alkyldialkoxyamine oxide, dialkylalkoxyamine oxide, dialkyletheramine oxide and dialkoxyetheramine oxide. In an embodiment, R₁ is an alkyl group having 4-18 carbons and R₂ and R₃ are alkyl groups having 1-18 carbons. In an embodiment, R₁ is an alkyl group having 6-10 carbons and R₂ and R₃ are alkyl groups having 1-2 carbons. In an embodiment, R₁ is an alkyl group having 8 carbons (an octyl group) and R₂ and R₃ are alkyl groups having 1-2 carbons. In an embodiment, R₁ is an alkyl group having 12 carbons (a lauryl group) and R₂ and R₃ are alkyl groups having 1-2 carbons. In some embodiments, the amine oxide is octyldimethylamine oxide, myristyldimethylamine oxide, didecylmethylamine oxide, methylmorpholine oxide, tetradecyldiethoxyamine oxide, or lauryldimethylamine oxide.

In some embodiments, accordingly, the peracid is peroxyacetic acid, the organic acid is lactic acid, and the optional anionic surfactant is sodium lauryl sulfate. In other embodiments, the concentration of peracid acid in the composition is from 3 to 100 ppm (w/w), the concentration of 2-hydroxy organic acid in the composition is from 0.1% to 2% (w/w); and the concentration of the anionic surfactant in the composition is from 10 to 2500 ppm, and the pH is between 2.5 and 5.0. In a still further embodiment, the concentration of peracid is 5 to 100 ppm (w/w), the concentration of 2-hydroxy organic acid is 0.1 to 2% (w/w), and the concentration of anionic surfactant is 50 to 400 ppm.

Generally, the concentration of hydrogen peroxide in the aqueous compositions is 5-fold to 10-fold less that the concentration of the peracid and its presence may reflect the equibilibrium or interconversion of the peracid with the corresponding acid and hydrogen peroxide. The concentration of the hydrogen peroxide can be for instance less than 5 ppm, 10 ppm or 20 ppm depending upon the selection and concentration of the peracid. Accordingly, the concentration of hydrogen peroxide in the aqueous composition is typically much less than that of the peracid.

Accordingly, in some embodiments, the invention provides an aqueous composition comprising i) an organic peracid of the formula RC(O)OOH wherein R is methyl, ethyl, n-propyl, or s-propyl; ii) a 2-hydroxy organic acid selected from tartaric acid, citric acid, malic acid, mandelic acid, and lactic acid; and, optionally, iii) an anionic surfactant; wherein the aqueous composition has a pH from 2.5 to 6.0, 4.0 to 6.0, 3.5 to 4.5, 3.0 to 5.0, 3.6 to 4.2, from 2.5 to 5.0, 2.5 to 4.5, 2.5 to 3.5, 2.7 to 3.5, 3.6 to 4.6, 2.8 to 3.2, inclusive, or about 3.0 (e.g., 3.0+/−0.2; 3.0+/−0.3); and the concentration of peracid is from 40 to 250 ppm (w/w) inclusive, and the concentration of the 2-hydroxy organic acid is from 0.1 to 1% (w/w), inclusive. In further embodiments, the aqueous composition has a peracid which is peroxyacetic acid and a 2-hydroxy organic acid which is L-(+)-lactic acid. In still further embodiments, the concentration of the peroxyacetic acid in the composition is from 50 to 100 ppm (w/w), the concentration of the lactic acid in the composition is from 0.1% to 0.6% (w/w). A preferred aqueous composition has a concentration of peroxyacetic acid from 60 to 80 ppm (w/w) and a concentration of lactic acid of from 0.1% to 0.4% (w/w). In other embodiments of any of the above the pH falls in a range selected from 2.5 to 4.5, 2.8 to 3.2, 2.5 to 5.0, and 2.7 to 3.5. In other embodiments of any of the above, the composition is at a temperature of 35° F. to 45° F. or at ambient temperature. These aqueous compositions can be substantially free of surfactants including any or all of nonionic surfactants, cationic surfactants or anionic surfactants. Generally, low levels of hydrogen peroxide from 1 to 20 ppm, 5 to 15 ppm, or 7 to 12 ppm may be present in the composition. Any peroxy 2-hydroxy organic acid formed or present in the aqueous composition can be present in an amount which is less than 1/10^{th}, ⅕^{th}, 1/20^{th}, or 1/50^{th} the amount of the corresponding 2-hydroxyorganic acid in the composition.

In some embodiments, the aqueous composition is formed by adding a composition of the 2-hydroxy organic acid which is substantially free of hydrogen peroxide to a composition of the peracid or by adding a composition of the peracid to a composition of the 2-hydroxy organic acid which is substantially free of hydrogen peroxide. The resulting mixture can be a concentrate or pre-blend as described above or in a sanitizing concentration suitable for contacting with an item as described herein. In other embodiments, the organic acid which is substantially free of any hydrogen peroxide and the peracid are added separately to an aqueous fluid used to wash or sanitize the item. In some embodiments, the pH and/or the concentration of the peracid and/or the concentration of the 2-hydroxy organic acid in the composition is maintained by monitoring one or more of the pH, concentration of the peracid, concentration of the 2-hydroxy organic acid, or oxidation reduction potential of the composition and adding a concentrate or pre-blend of the aqueous composition to maintain the pH, the concentration of the peracid and lactic acid in the aqueous composition during use of the composition in contacting the item.

Any of the above compositions of the invention may in particular further comprise an agent to reduce or suppress sudsing or foaming of the composition during use or contact with the item. The compositions according to the invention may also be essentially free of any nonionic and/or cationic surfactant and/or also be essentially free of any thickening agent.

In an additional embodiment, the aqueous composition of the invention has a concentration of peracid in the composition from about 60 to 80 ppm (w/w), a concentration of 2-hydroxy organic acid in the composition of from about 0.2% to 1.25% (w/w); and a concentration of anionic surfactant in the composition of from about 150 to 200 ppm (w/w), and a pH between about 3.8 and 4.2, inclusive or 3.8 and 4.2, inclusive.

The aqueous compositions according to the invention may also optionally include a sequestering agent that chelates metals that catalyze the decomposition of hydrogen peroxide. These agents include, but are not limited to, organic phosphonic acids capable of sequestering bivalent metal cations, as well as the water-soluble salts of such acids. A common chelant is 1-hydroxyethylidene-1,1-diphosphonic acid. The chelants present in the sanitizer composition are typically diluted upon use, thus minimizing their effect during use. In particular, an aqueous sanitizer composition of the invention can optionally contain an agent to chelate magnesium or calcium.

Without being wed to theory, the presence of the optional anionic surfactant may serve to reduce the surface tension and viscosity of the aqueous composition and facilitate the spread of the composition over the surface of the item. The low viscosity improves the completeness of the treatment by promoting spreading over the surface of the food, especially where there are layers, rugosities, etc. The low viscosity also improves rinsing properties and the speed of any residual drying.

In some embodiments, the aqueous composition is capable of reducing a microbial contamination on the surface of the item by at least 1 or 2 log units, more preferably, by at least 3 log units, and still more preferably by at least 4, log units. Suitable methods for determining the fold reduction are well known in the art and also exemplified in the Examples (e.g., using E. Coli or Listeria pathogen surrogates attached to lettuce leaves). In other embodiments, the method inhibits spoilage or prolongs shelf-life of a food item (e.g., produce) by 10%, 20%, 30, 40%, 20 to 50% or by 1, 2, 3, 4, or 5 days according to any method as described in the Examples.

The compositions may be provided as a pre-blend or concentrate which is diluted with water to achieve a sanitizing composition for contacting with an item as described herein. Pre-blends or concentrates are contemplated which require a 4- to 200-fold, 10 to 100-fold, 10 to 50-fold, 10 to 25 fold, 4 to 10-fold dilution with water before use (e.g., about a 5-, 10-, 20-40-, 50, 100-fold dilution).

The term “substantially free” generally means the referenced substance is absent or present as a minor constituent which may not materially change the properties of the referenced material. With respect to hydrogen peroxide, a 2-hydroxy organic acid composition which is substantially free of hydrogen peroxide can be one which has no hydrogen peroxide or else has an amount of hydrogen peroxide which is less than 0.1 ppm (w/w). With respect to a peroxy 2-hydroxyorganic acid, a sanitizing composition is substantially free of the 2-hydroxy organic peracid if the 2-hydroxy organic peracid is absent in a referenced composition or is present in an amount which is less than 1/10^{th}, 1/20^{th}, 1/40^{th} or 1/100^{th} of that of the corresponding 2-hydroxy organic acid or is present only as a reaction product first formed by a reaction of the 2-hydroxy organic acid in composition containing hydrogen peroxide and an organic peracid of the formula RC(O)OOH wherein R is methyl, ethyl, n-propyl, or s-propyl. Accordingly, in some embodiments, the sanitizing composition or 2-hydroxy organic acid composition used in the making of the sanitizing composition is substantially free of a peracid of the 2-hydroxy organic acid.

The disinfectant or sanitizing compositions of the present invention can be in a variety of forms including aqueous solutions, suspensions, gels, foams, fogs, sprays and wipes. Additional types of products include disinfectant foams, creams, mousses, and the like, and compositions containing organic and inorganic filler materials, such as emulsions, lotions, creams, pastes, and the like. The disinfectant or sanitizing compositions can also be used as disinfectant fogs and disinfectant mists. The present compositions can be manufactured as dilute ready-to-use compositions, or as concentrates that can be diluted prior to use. The various p compositions may also include fragrances, depending on the nature of the product. For example, a pine or lemon fragrance may be desirable for use for kitchen cleaning wipes because of their appealing association with cleanliness to many consumers. Further, gels or aerosols may also be fragranced for similar or other reasons. In some embodiments, the principal component by weight of the composition is water. In some embodiments, the composition according to the invention is at least 50%, 60%, 70%, 80%, 90%, 95%, 98% or 99% water by weight.

In one embodiment of the present invention, the disinfectant compositions are used to make disinfectant wipes. The disinfectant wipes of the present invention can be used to clean a variety of hard and other surfaces, including human hands and skin, medical instruments, countertops, sinks, floors, walls, windows, etc. The wipes of the present invention can be made of a variety of fabrics. For the purposes of the present invention, fabrics can include cloths and papers, as well as woven and non-woven materials. The woven or nonwoven fabrics can be made of suitable materials such as rayon, nylon, or cotton, linen, combinations thereof. Examples of nonwoven fabrics are described in U.S. Pat. Nos. 3,786,615; 4,395,454; and 4,199,322; which are hereby incorporated by reference. The fabrics or papers can be impregnated with the disinfectant composition by any method known in the art. The wipes can be packaged individually or in any manner known in the art including individual blister-packs or wrapped or stacked multi-packs.

In another embodiment, the disinfectant composition of the present invention is formulated into a gel or gelatinous sanitization composition. In addition to the disinfectant compositions, the gel sanitizers of the present invention can include a thickening or gelling agent, wherein “thickening agent” and “gelling agent” are used interchangeably. For the purposes of the present invention, the terms “gel” or “gelatinous” sanitization compositions refers to a disinfectant liquid substances that can have a viscosity from about 1,000 centipoise to about 100,000 centipoise, or from 2,000 centipoise to 50,000 centipoise in another embodiment, though these ranges are not intended to be limiting. A hand gel may be considerably less viscous than a gel used for industrial cleaning or disinfectant purposes. Examples of gelling or thickening agents include but are not limited to natural gum such as guar and guar derivatives, a synthetic polymer, an acrylate homopolymer, an acrylate copolymer, a carbomer, cellulose, a cellulose derivative, algin, an algin derivative, a water-insoluble C₈-C₂₀ alcohol, carrageenan, a clay, an oil, a wax, aloe vera gel, fumed silica, mixtures thereof, and the like. The gelling agent can be present in the gelatinous sanitation composition in an amount from about 0.1 wt % to 50 wt % of the gelatinous composition. In another embodiment, the gelling agent is present in an amount from 0.25 wt % to 10 wt % of the gelatinous composition. The amount of gelling agent can be dependent on a variety of factors including the type of gelling agent and the desired viscosity of the gel. The gelatinous sanitizers can be used for a variety of applications. In one particular embodiment, the disinfectant composition can be mixed with natural aloe gel to form a disinfectant aloe formulation. Such formulations are especially favored where skin contact may occur or is intented.

In another embodiment, the disinfectant composition of the present invention can be formulated into a disinfectant foam or foaming composition. The disinfectant foams or foaming compositions include the disinfectant composition and foaming agents. Any foaming agent known in the art can be used depending on the desired application and characteristics of the resulting disinfectant foam.

In another embodiment, the disinfectant composition of the present invention can be in the form of a disinfectant aerosol or fog. Fogging is a process by which disinfectants are aerosolized. The aerosol particles of the disinfectant are suspended within the air for a period of time in order to disinfect both the air itself and surfaces, including inaccessible parts of a structure such as air vents. The aerosolized particles of disinfectant can have a particle size of from about 5 micrometers to about 200 micrometers. In another embodiment, the aerosolized particle can have a particle size of from about 20 micrometers to about micrometers.

Fogging can have a major part to play in disease prevention and control. Most fogging machines work by using high volumes of air under great pressure to generate small droplets. The disinfectants compositions of the present invention are compatible with most standard fogging machines. Examples of suitable fogging machines include Dyna-Fog's® Thermal Foggers and Cold Foggers.

As a composition, the composition can be used as a liquid dispersion bath for objects such as instruments or as a spray for applying to less mobile objects.

### Containers and Kits

In some embodiments, the invention provides a kit comprising the aqueous sanitizing composition according to the invention and instructions for its use in the treatment of fomites or other items as described above. In some further embodiments, the kit provides a first part comprising a peracid composition that is at or near equilibrium. Typically the composition is provided ready to use or else comprises about 5% to about 35% by weight of a peracid, such as peroxyacetic acid, or mixture of peracids and comes with instructions as to how much it should be diluted with water prior to use. The kit contains a soaking bowl and strainer. The ready-to-use formulation may be provided in a spray bottle. In other embodiments, the kit may provide the aqueous sanitizing composition as a concentrate in one container along with a re-fillable spray bottle optionally containing an amount of the ready-to-use formulation. This kit would include directions as to the appropriate factor of dilution to use when bringing up the concentrate with water. Typically, the concentrate would be 4, 5, 6, 8, 10 or 20-fold more concentrated than the ready to use formulation. Such kits would be especially suitable for consumer use.

### Methods of the Invention

In a second aspect, the invention provides a method of sanitizing items, said method comprising contacting the item with an aqueous sanitizing composition according to the invention. The composition can be contacted or applied to the item by any suitable means as known to persons of ordinary skill in the art. For instance, the composition can be applied by any method that insures good contact between the surface to be sanitized and the sanitizer composition. Such methods include bathing, washing, coating, brushing, dipping, immersing, wiping, misting, spraying, and fogging. These steps may be repeated to assure a thorough contacting. Once applied, after a residence time sufficient to assure the desired degree of sanitizing action (e.g., at least 2, 3, 4, 5, 6, 7, or 8 log fold-removal of a microbial contaminant), the composition may be physically removed from the surface of the item by centrifugation and/or draining/and/or rinsing or washing the item with water suitable for use on foods (e.g., potable water). Any combination of these removal steps may be performed in any order. The rinsing is not essential where the peracid, 2-hydroxy organic acid, and sodium lauryl sulfate are present in GRAS amounts. In particular, the peracids preferably used are volatile and, hence, would leave little residue on the item upon drying.

The residence time will vary with the concentration of the peracid (e.g. peroxyacetic acid), the 2-hydroxyorganic acid (e.g., L-(+)-lactic acid, and the surfactant (if any). However, generally, it is contemplated that the surface of the item may be contacted with the aqueous sanitizer composition for a residence time of from about 10 seconds to about 10 minutes. More preferably, the residence time is from about 20 seconds up to about 1, 2 or 4 minutes. The residence time can vary in accordance with the temperature and concentration of the peracid and 2-hydroxyorganic acid. Lower temperatures and concentrations would require longer contact times as could be readily empirically determined by a person of ordinary skill in the art.

The temperature at which the aqueous sanitizer composition/rinse composition is applied should be in accordance with the thermal tolerance of the item. The sanitizer composition can be effectively applied at temperatures suitable for liquid water. Conveniently, the temperature can be ambient or room temperature (e.g., 20° C. to 35° C.). However, other temperatures can be used in accordance with the heat tolerance of the item being treated or the source of the water to which the peracid and or 2-hydroxy organic acid is added.

In some embodiments, the contacting reduces a microbial contamination on the surface of the item by at least 3 or 4 log units, more preferably, by at least 5 log units, and still more preferably by at least 6, 7, or 8 log units. The contaminant can be human pathogen (e.g., E. Coli, a strain of E. coli O157H7, Listeria monocyogenes, Salmonella) or an indigenous microorganism typically found on the surface of item.

The aqueous sanitizing composition according to the invention can be used on items in both domestic and commercial applications.

In some embodiments, the microbial contaminant to be reduced by the treatment is a human pathogen (e.g., enterotoxic bacterium), including but not limited to, a bacterium (e.g., E. coli O157H7, Listeria moncytogenes, Salmonella), virus, a fungus, or a mold.

It has also been surprisingly found that the co-formulation of the peracid (e.g., peroxyacetic acid) with the 2-hydroxy organic acid (e.g., L-(+)-lactic acid) in the aqueous sanitizer composition provides a particularly effective and long-lasting sanitizer composition when in use. When in continuous use to treat a plurality of items, the composition has to be refreshed or supplemented with additional peracid and 2-hydroxyorganic acid to maintain a concentration of the peracid in a range of from about 60 to 80 ppm and the lactic acid in a concentration of from 0.2 to 0.4%, or about 2.5%.

In some embodiments, the sanitizing composition is provided as an aqueous pre-blend mixture (e.g., about a 5-200-fold concentrate, a 5-, 10-, 20-, 40-, 50- or 100-fold concentrate) to be added to the water to be contacted with the item. In some embodiments, the concentration of peracid and/or 2-hydroxyorganic acid is adjusted in the wash composition to maintain their concentration(s) by addition of the pre-blend or concentrate based upon the concentration of the peracid and/or 2-hydroxy organic acid in the wash composition as determined by actual measurement or historical consumption data.

In commercial applications, in some embodiments, the item is transported to a sanitizing composition (e.g. solution) where the item is contacted with the sanitizing composition by immersion in the composition. Air bubbles can be generated to facilitate the contacting and/or the mixing of a pre-blend. The item is then removed from the sanitizing composition, optionally rinsed by spraying with water free of a peracid and 2-hydroxy organic acid/and or by being immersed in water free of a peracid and 2-hydroxy organic acid. The rinse water can be further removed by shaking, centrifuging, air drying, or toweling the item.

The present reduced-odor compositions can be employed for reducing the population of pathogenic microorganisms, such as pathogens of humans, animals, and the like. The reduced-odor compositions can exhibit activity against pathogens including fungi, molds, bacteria, spores, and viruses, for example, parvovirus, coxsackie virus, herpes virus, S. aureus, E. coli, Streptococci, Legionella, mycobacteria, or the like. Such pathogens can cause a varieties of diseases and disorders, including athletes foot, hairy hoof wart disease, mastitis or other mammalian milking diseases, tuberculosis, and the like. In addition, the present compositions can kill pathogenic microorganisms that spread through transfer by water, air, or a surface substrate. A filter containing the composition can reduce the population of microorganisms in air and liquids.

A concentrate or use concentration of a reduced-odor peroxycarboxylic acid composition (e.g. solution) of the present invention can be applied to or brought into contact with an item by any conventional method or apparatus for applying an antimicrobial or cleaning composition to an object. For example, the object can be wiped with, sprayed with, and/or immersed in the reduced-odor composition, or a use composition made from the reduced-odor composition. Contacting can be manual or by machine.

The present methods require a certain minimal contact time of the composition (e.g. solution) ith the item for occurrence of significant antimicrobial effect. The contact time can vary with concentration of the use composition, method of applying the use composition, temperature of the use composition, amount of a contaminant on the item, number of microorganisms on the item, the environment, the desired degree of sanitizing, and the like. Preferably the exposure time is at least about 5 to about 15 seconds.

In one embodiment, a pressure spray is used to apply a composition (e.g. solution) according to the invention. During application of the spray solution on the item, the surface of the item can be moved with mechanical action, preferably agitated, rubbed, brushed, etc.

Agitation can be by physical scrubbing of the item, through the action of the spray solution under pressure, through sonication, or by other methods. Agitation increases the efficacy of the spray solution in killing micro-organisms, perhaps due to better exposure of the solution into any crevasses or small colonies containing the micro-organisms. The spray solution, before application, can also be cooled to a temperature from 2 to 5° C., 2 to 10° C. for heat intolerant items or heated to a temperature of about 15 to 20° C., preferably about 20 to 60° C. to increase efficacy for a heat tolerant item.

Spray applications can be performed automatically (as in the case of a production line) or manually. Multiple spray heads can be used to ensure complete contact or other spray means. The spray heads can have any useful spray pattern. A spray booth can be used to substantially confine the sprayed composition (e.g. solution) to within the booth. For instance, a production line item can move through the entryway into the booth where all its exterior surfaces are contacted. After allowing some time for drainage from the surfaces, the item can then exit the booth in a fully treated form. A spray booth can employ steam jets to apply the antimicrobial or sanitizing composition (e.g. solution) of the invention. These steam jets can be used in combination with cooling water to ensure that the treatment reaching the item is at the desired temperature and that the item is not undesirably altered (e.g., cooked) by the temperature of the spray.

In some embodiments, the item is immersed into a tank containing a quantity of a composition (e.g. solution) according to the invention. The composition is preferably agitated to increase the efficacy of the composition and the speed in which the composition reduces micro-organisms accompanying to the poultry product. Agitation can be obtained by conventional methods, including ultrasonics, aeration by bubbling air through the composition, by mechanical methods, stirring, such as strainers, paddles, brushes, pump driven liquid jets, or by combinations of these methods. In some embodiments, the sanitizing composition can be heated to increase the efficacy of the solution in killing micro-organisms.

In another alternative embodiment of the present invention, the item can be treated with a foaming version of the composition according to the invention. The foam can be prepared by mixing foaming surfactants with the sanitizing solution beforehand or at time of use. The foaming surfactants can be nonionic, anionic or cationic in nature. Examples of useful surfactant types include, but are not limited to the following: amine oxides, alkli sulfates, alkyl ether sulfate, sulfonates, quaternary ammonium compounds, alkyl sarcosines, alcohol ethoxylates, alcohol ethoxylate carboxylate, betaines and alkyl amides. The foaming surfactant can be mixed at time of use with the other ingredients to make the sanitizing composition. Use solution levels of the foaming agents is from about 50 ppm to about 2.0 wt-%. At time of use, compressed air can be injected into the mixture, then applied to the item through a foam application device such as a tank foamer or an aspirated wall mounted foamer.

In another embodiment of the present invention, the item can be treated with a thickened or gelled version of the composition which can adhere to the surfaces. The composition or the sanitizing composition can be thickened or gelled using existing technologies such as: xanthan gum, polymeric thickeners, cellulose thickeners or the like. Rod micelle forming systems such as amine oxides and anionic counter ions could also be used. The thickeners or gel forming agents can be used either in the concentrated product or mixing with the sanitizing solution, at time of use. Typical use levels of thickeners or gel agents range from about 100 ppm to about 0.1 wt-% or from about 0.1 wt-% to 1 wt-%, or from 1 wt-% to 10 wt-%. In the thickened or gelled state the sanitizing solution remains in contact with the item for longer periods of time, thus increasing the antimicrobial efficacy.

The following examples are intended to illustrate, but not limit, the invention.

### EXAMPLES

### Example 1

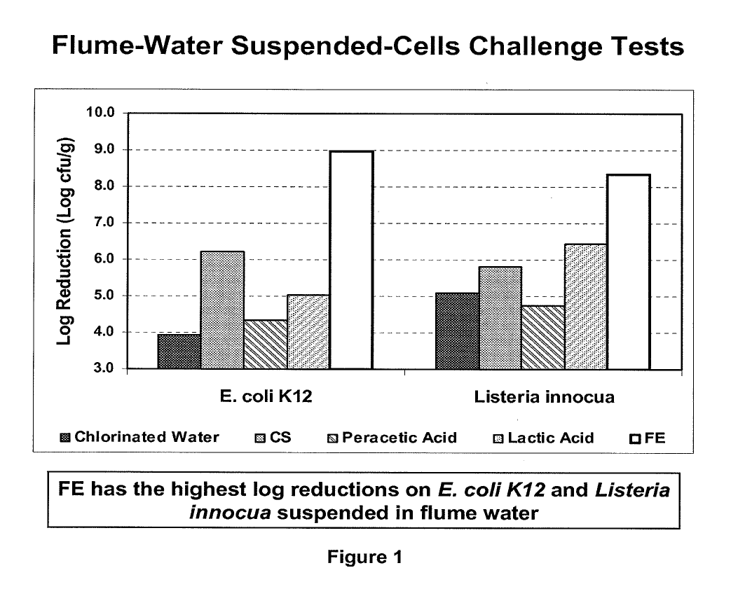

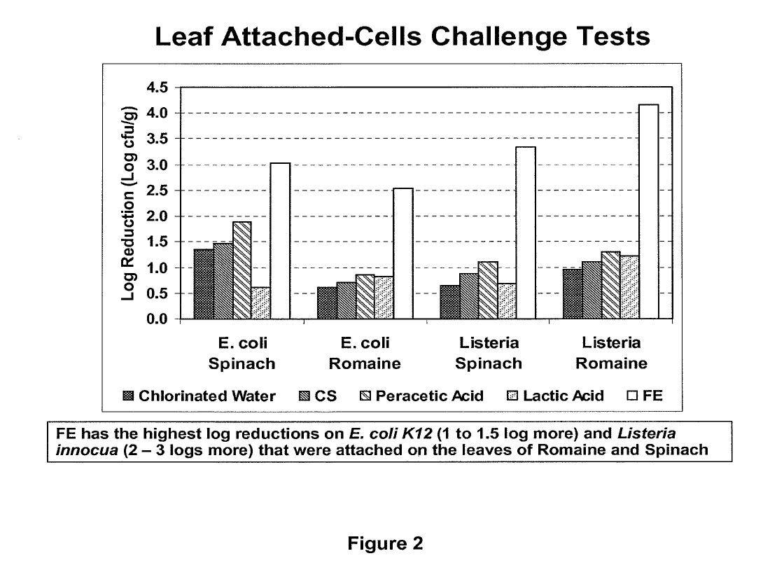

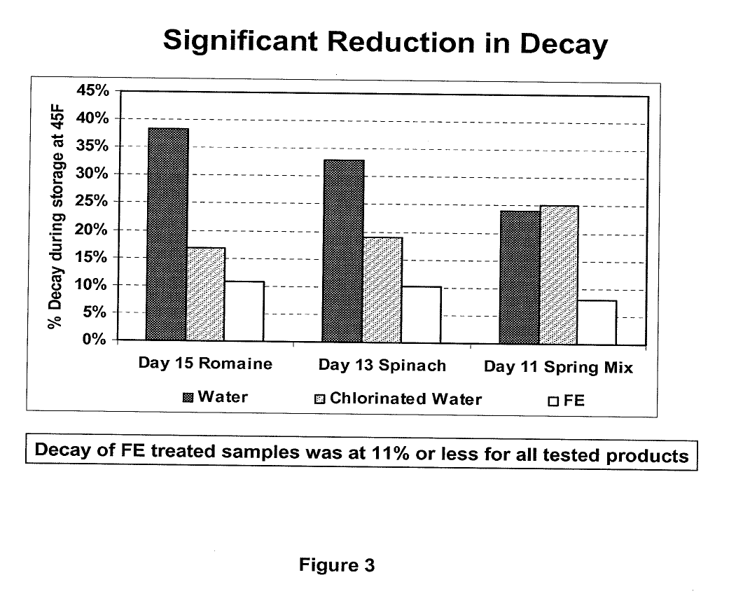

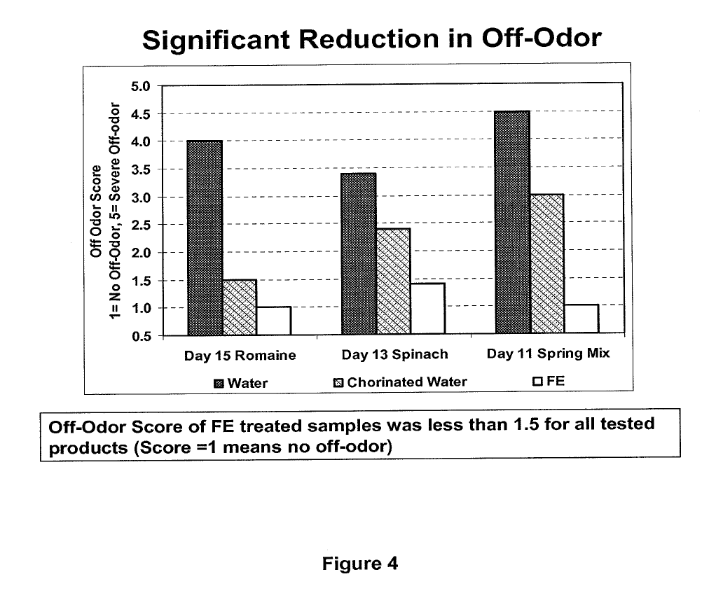

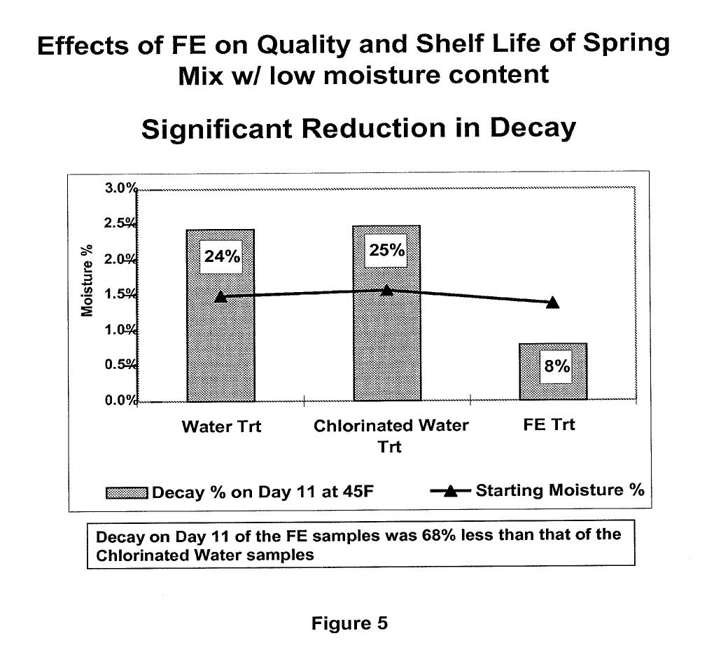

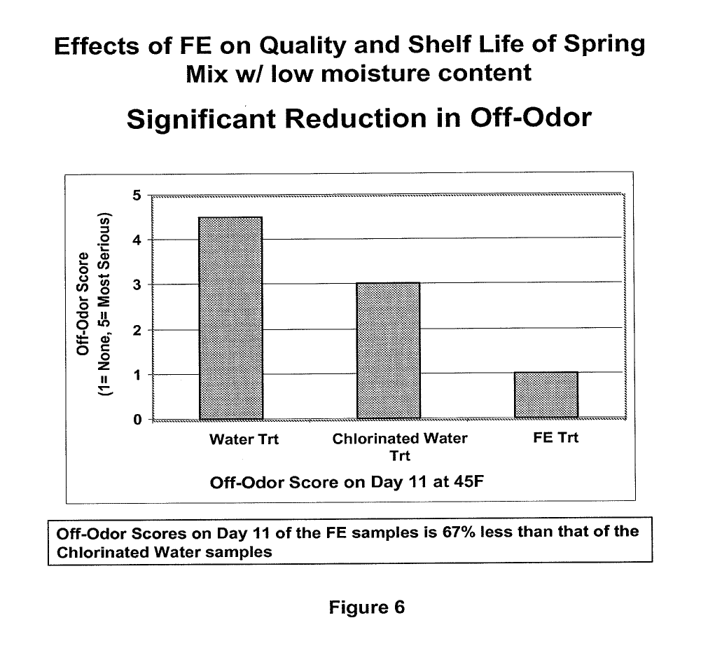

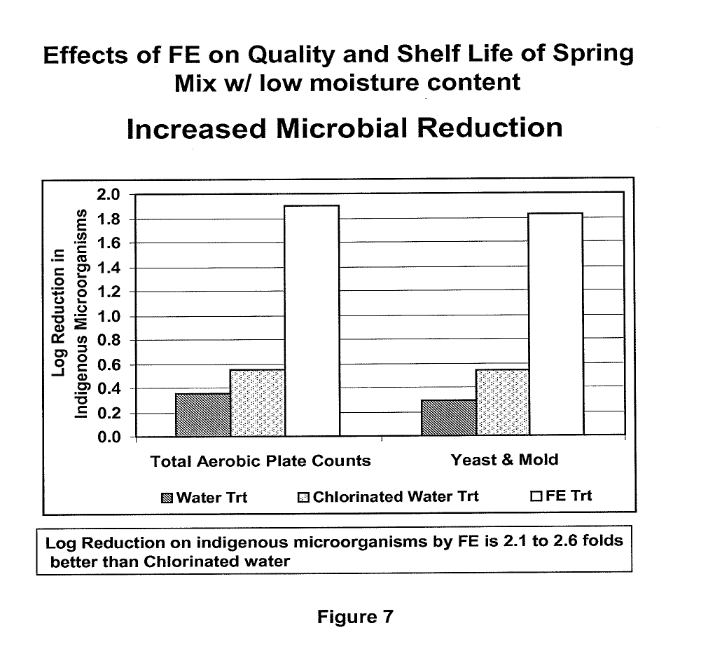

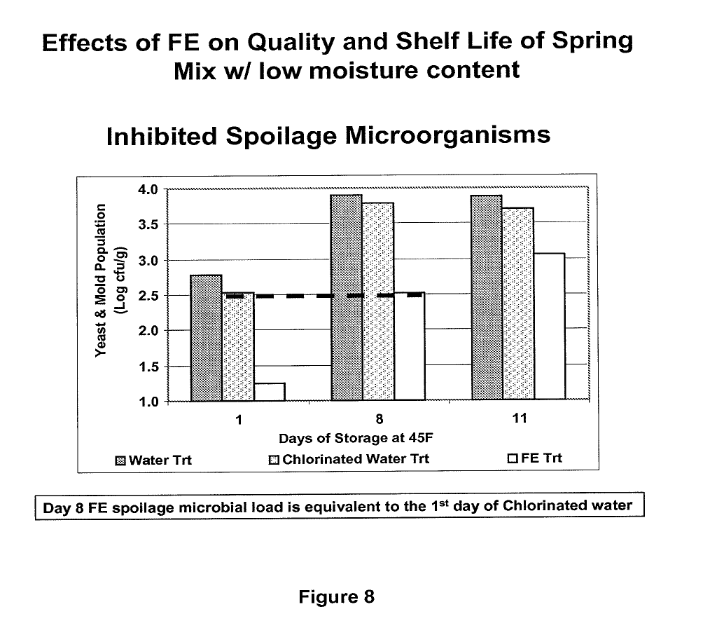

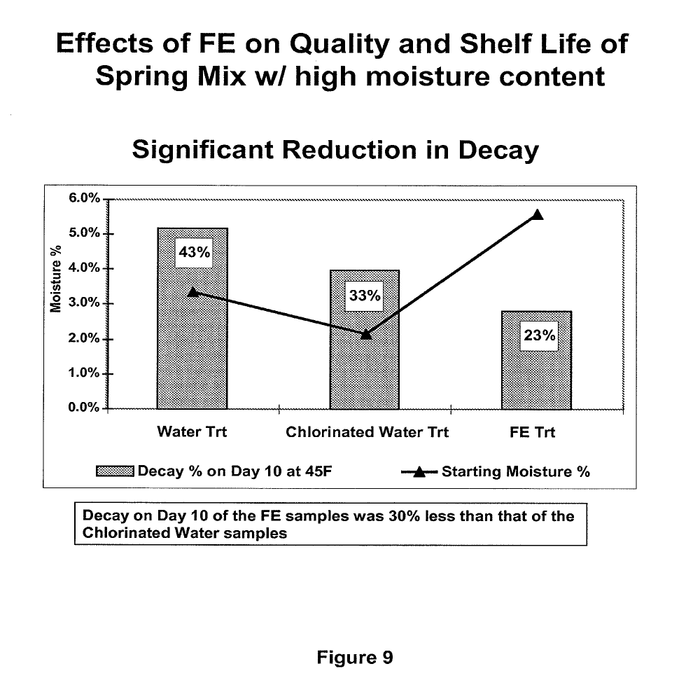

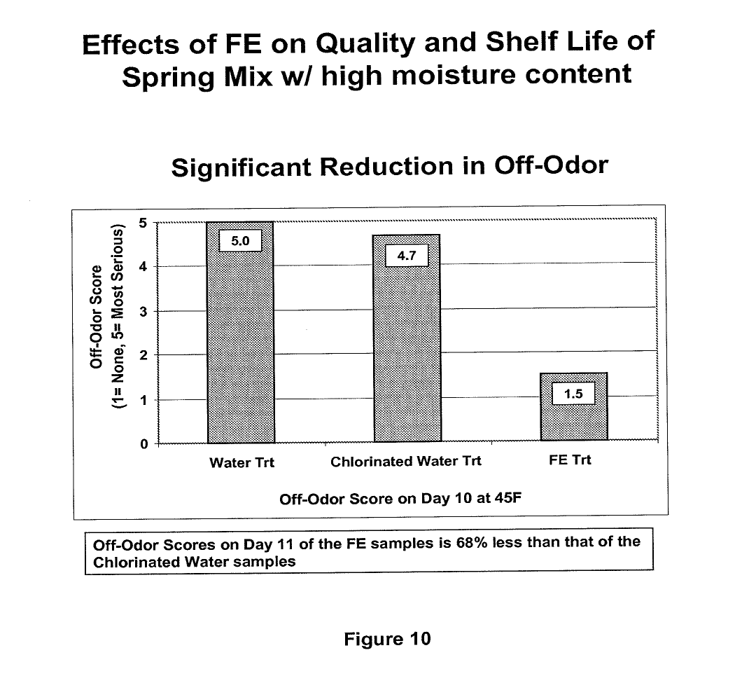

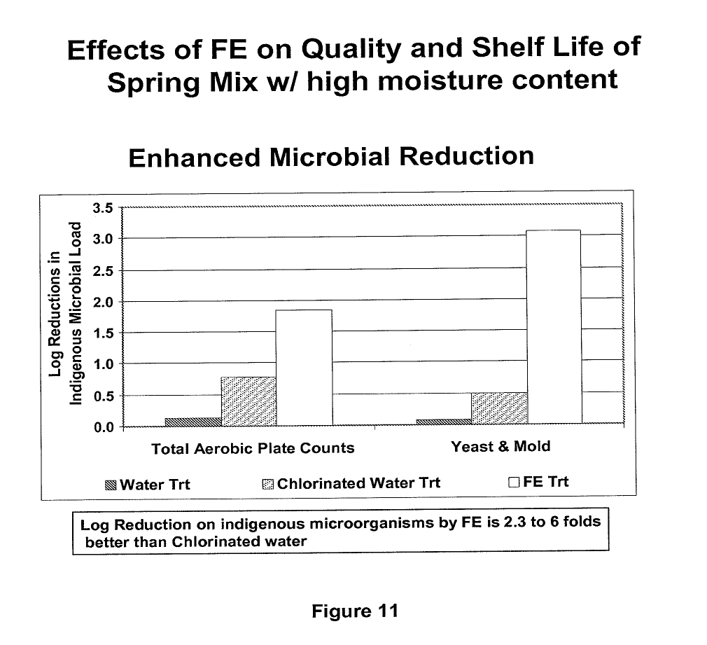

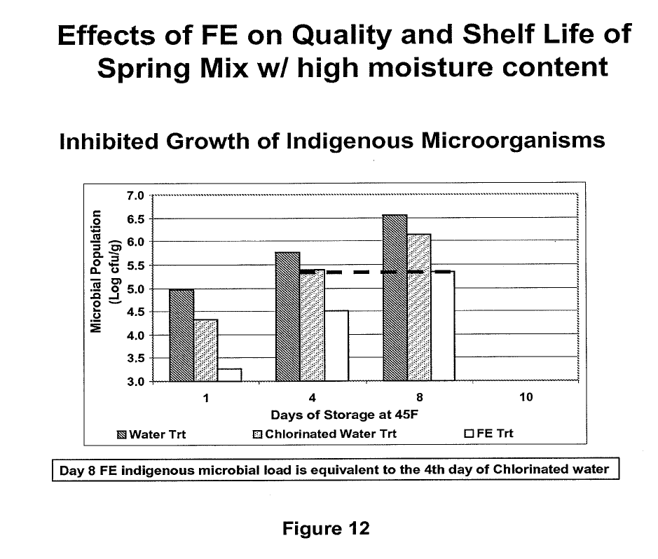

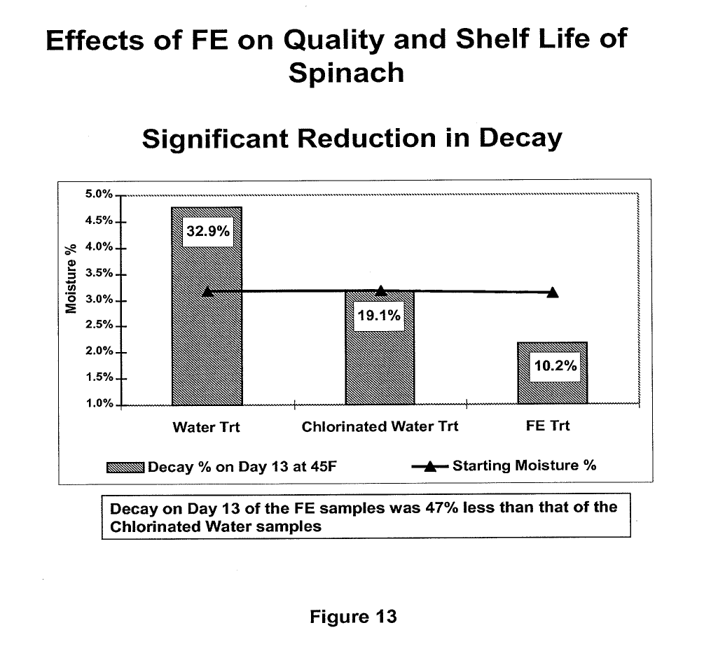

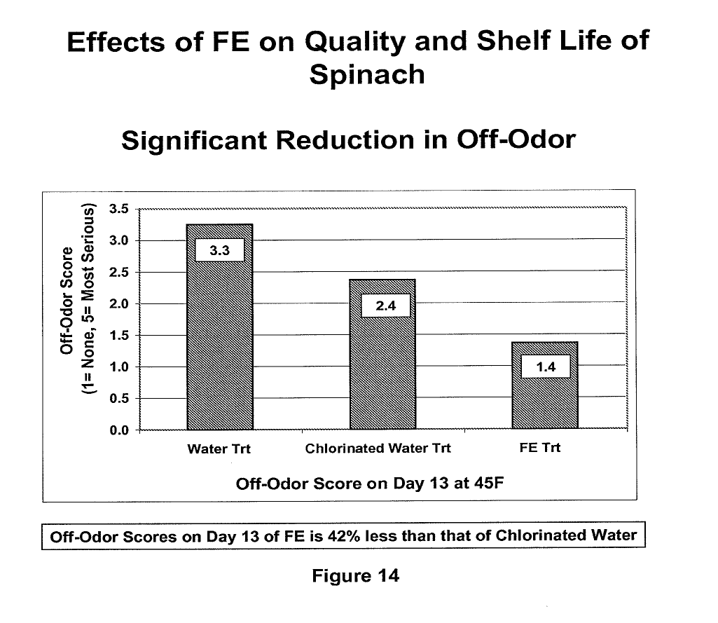

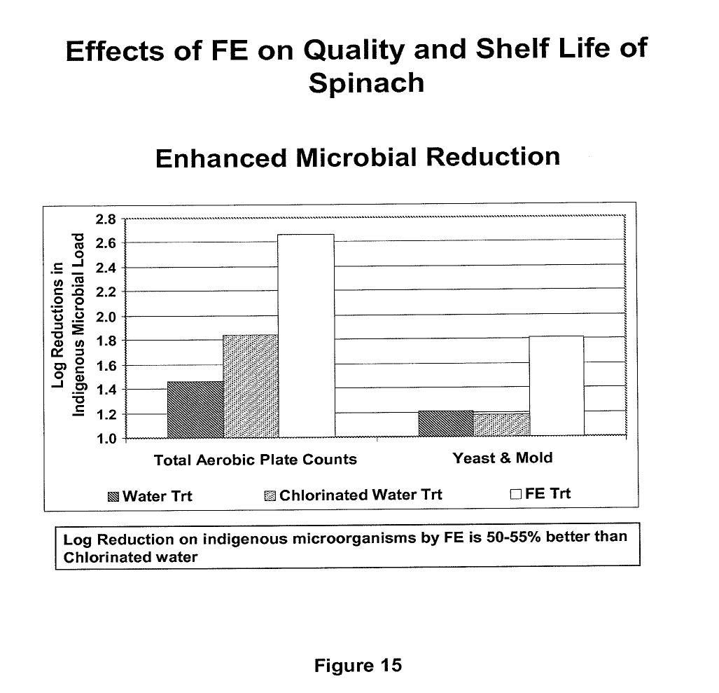

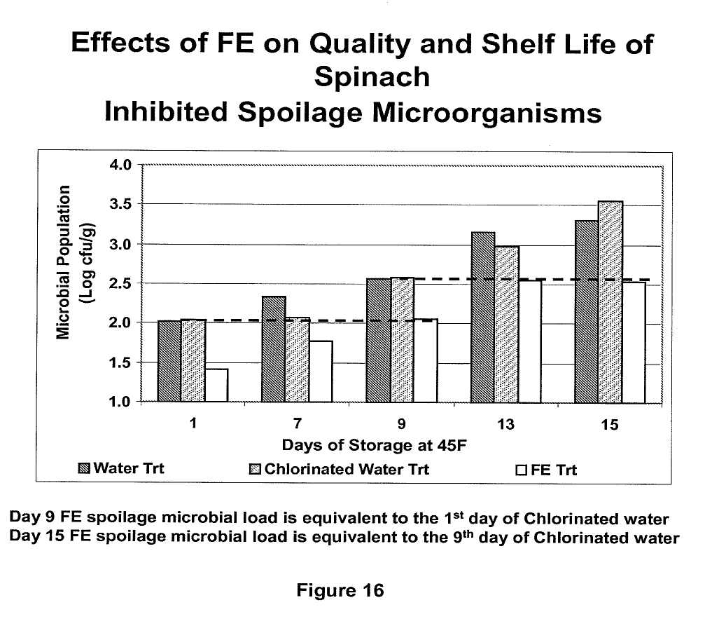

The present example illustrates the use of an aqueous sanitizing composition according to the invention. As illustrated in FIGS. 1 to 16, the compositions according to the invention advantageously remove microorganisms from the surface of a variety of items, inhibiting the growth of indigenous microorganisms on the treated item, and can remove model pathogens from the surface of the item. The methods and compositions of the invention are also shown to greatly improve the shelf-life of a spoilable item and greatly retard decay of a spoilable item. The findings extend to such diverse microorganisms as bacteria, yeast, and mold.

### A. Standard Operating Procedure for Shelf Life Study

This method can be used to determine the shelf life of produce that has been treated by a sanitizing solutions, generally and, particularly, those according to the invention.

### Preparation

Cooled eight 20-gallon containers with 75% water to ˜45° F.

Autoclave twelve 5-gallons tubs wrapped well in tin foil at least 1 day in advance of processing.
1. Depending on the type of produce, use the corresponding OTR tubes; cut, marked, and sealed to form bags. Place the bags under an UV light in the biological safety cabinet for 2 h to minimize contamination.

### Processing

1. Formulate chemical sanitizers immediately before usage. All calculations are based on mass/mass.
2. Fill containers to ¾ full only so as to prevent overflowing during processing
3. Place raw product gently into a stainless steel basket with lid and fill it to ¾ full.
4. Start the timer when the basket is submerged into the chemical sanitizer
5. Cycle up and down the filled basket gently for 30 s
6. Remove the treated basket with produce from the container with chemical solution and immediately transfer it into another container ¾ filled with water for rinsing
7. Cycle up and down 10 times in water to remove the majority of residual chemical on the treated produce surface
8. Place the basket with the treated produce in an inverted manner and empty the contents gently into a dryer bin liner
9. Repeat Steps ‘3’ to ‘8’ until there the dryer bin liner is full. Closed the dryer lid and centrifuge for 20 min
10. Empty the dried produce from the bin liner to sterile tubs and let the dried treated produce sit for an extra 10-15 minutes for moisture equilibration with the environment to achieve the same moisture content as the corresponding production facility.
11. Clean all tools, equipment, and containers
12. Repeat Steps ‘1’ to ‘11’ for other sanitizer treatments

### Bagging and Sealing

1. Tare the scale with the bag every time.
2. Fill the bag with the target produce mass
3. Seal bags with a proper sealing machine
4. Store in boxes at 45 F and perform evaluations: microbiological analysis, Open Bag Evaluation (OBE), visual inspection on the appropriate days of interest.

### Evaluations

1. Use the appropriate forms for OBE.
2. Visually inspect the produce and photographs the differences of the samples from various chemical
   a. OBE moisture determination-weigh initial mass of leaves, spread leaves onto folded paper towels and blot dry by pressing hands to remove exterior moisture and take a final weight.
   Calculations:
      Volume to be used of a stock solution with a concentrated solution:

$${M}_{stock} = \frac{[ Desired ] {M}_{desired}}{[ Stock ]}$$

Moisture difference:

Difference=(M_{before})−(M_{after})
Moisture Percentage:

$${\%}_{moisture} = \frac{( {M}_{befire} ) - ( {M}_{after} )}{( {M}_{before} )}$$

3. For visual analysis be sure that bags are labeled before first analysis to follow the same bags throughout shelf-life
4. Enumerate microbial population of the treated produce using serial dilution and spread plating.
5. Samples for microbial and OBE analysis may be retrieved, for instance, on days 1, 5, 7, 9, 12, and 15.

### B. Standard Operating Procedure for Suspended Cells Challenge Test

This procedure is used to determine the antimicrobial activity of sanitizers on microorganisms that are suspended in a liquid.

### Processing Parameters and Treatments

1. Temperature: 45 F
2. Residence time: 30+/−10 secs
   pH: 3+/−0.3
3. Pathogen surrogates: E. coli K12, Listeria innocua
4. Spoilage microorganisms surrogates: Pseudomonas flourescens, Saccharomyces cerevisiae

### Running the Test

1. Transfer 1.00 mL of a 10⁸ cfu/g stock culture into a test tube containing 9.00 gm of tested solution
2. Vortex the mixture for 15 s
3. Stop the reaction by transferring 1 mL of the treated samples to 9 mL of Butterfield Phosphate Buffer
4. Enumerate viable residual cells through serial dilutions and spread plating
5. Ensure that the operating temperature is kept at 45+1° F. (only one test tube is removed out of the fridge at a time as the kinetics of chemicals change significantly if the whole test is run at room temperature)

### C. Standard Operating Procedure for Attached Cells Challenge Test

This method can be used to determine the antimicrobial activity of sanitizers on microorganisms that are attached on the surface of leaves

### Processing Parameters and Treatments

1. Temperature: 45° F.
2. Residence time: 45 s
3. pH: 3+/−0.3
4. Treatments: water, chlorinated water, CS, lactic acid, peroxyacetic acid, FE sanitizer (i.e., here, aqueous solutions comprising peroxyacetic acid and lactic acid) at 16 levels
5. Products tested: Romaine, spinach, spring mix
6. Pathogen surrogate: E. coli K12, Listeria innocua
7. Microorganisms tested: indigenous microorganisms on produce leaves (Total aerobic plate counts [APC], yeast, and mold [YM])

### Sample Preparation

1. Take 3-4 leaves of the tested produce and place them into a 6″×6″×5″ sterile polypropylene (PP) basket. If the tested produce is Romaine, cut the Romaine into 2″×4″ rectangles
2. Retrieve 1.00 mL of the 10⁸ cfu/g stock culture with a 1-mL pipette-man and slowly spike the leaves surface by dropping small size droplets of the innoculum onto the leaf surface. Be careful not to shake the PP basket and causes the droplets to fall out of the leaves prior to drying 3. Let the basket with the spiked leaves sit in a biological safety cabinet with a fan running (˜0.5 W.C.) for 1.75 hrs
4. Remove the PP baskets with spiked leaves from the cabinet and transfer them into a cold room/refrigerator at 40-45° F. for 0.25 hrs

### Treatment of Spiked Leaves

1. Place a PP basket with spiked leaves into a sterile container containing 3-L of 45 F water for 45 seconds with swirling
2. Rinse immediately for 10 seconds by dipping the treated basket into tap water at 45 F
3. Take treated leaves from the basket and place them into a stomacher bag by means of a sterile tong
4. Label the stomacher bag with the associated treatment for the leaves
5. Repeat the Step 1 to 4 with the other treatments of the test

### Enumeration of Treated Leaves

1. Add phosphate buffer into a stomacher bag with the treated leaves until a 10-fold dilution is attained
2. Stomach the bag with phosphate buffer and treated leaves for 30 seconds
3. Shake the leaves back into the phosphate buffer solution and repeat the stomaching for another 30 seconds
4. Remove buffer from stomached sample and enumerate for residual cells by serial dilution and spread plating
5. Repeat Step 1 to 4 for all other treatments

### D. Standard Operating Procedure for Preparation of Microbial Stock Culture

This procedure is used to prepare a 10⁸-10⁹ cfu/mL stock culture for suspended and attached cells challenge tests. The cell concentration of the stock culture is enumerated prior to testing solution.

1. Activation of Stock Culture
a. All procedures are done in a sterile environment (e.g. inside a Biological Safety Cabinet)
b. A loop of cells is retrieved from the pure stock culture by means of a sterile loop. The loop of cells is aseptically transferred into a test tube with 10-mL of sterile growth medium (broth).
c. Step “b” is repeated 3 times
d. Incubate inoculated tubes from Step “b” and “c” for 2 days under an optimal growing temperature for the microorganism to be activated
e. Step “b” to “d” is referred to as the first transfer (1^{st} T)
f. Retrieve 0.1-mL of growth medium from a test tube of the 1^{st} T and aseptically transfer it into another test tube with 10-mL of sterile growth medium
g. Verify that the tube from 1^{st} T has pure culture by spread plating a 50 to 100-uL sample of growth medium onto an agar plates
h. Repeat Step “g” 2 times
i. Incubate both the plates and transfer tubes #2 for two days at selected optimum temperature
j. Steps “f” to “i” are referred to as 2^{nd} T
k. Repeat Steps “f” to “i” with 100 mL growth medium for the 3^{rd} T
l. Store the resulted Erlenmeyer culture flasks from 3^{rd} T in refrigerator overnight
m. Take the 3^{rd} T flask from Step “1” and transferred it equally into 4 centrifuge tubes
n. Centrifuge the tubes with pure stock culture at 10,000 RPM for 10 minutes
o. Decant immediately the growth medium. A pellet of cells would be formed at the bottom of the centrifuged tube
p. Add the same amount of sterile de-ionized water to the pellet of cell
q. Vortex to loosen and re-suspend the pellet of cells
r. Repeat Step “n” and “o” two more times
s. To obtain a final 10⁸-10⁹ cfu/gm of suspended cell culture, add 1/10 of the initial volume of sterile de-ionized water to the cell pellet of Step “r”
t. Consolidate all the re-suspended cell cultures into one centrifuge tube to form the final suspended stock culture

The effects of a sanitizing solution according to the invention on the removal of microbes on the surface of produce.

### Results

The following tables show the results of the suspended-cells challenge tests with and without surfactant:

| | Log Reductions | | |
|---|---|---|---|
| | PAA (ppm) | | |
| Concentration | 60 | 70 | 80 |

| | |
|---|---|
| Listeria Suspended | Surfactant No |

| | | | | |
|---|---|---|---|---|
| LA (%) | 0.6% | 3.4 | 5.0 | >8.4 |
| | 0.9% | 4.5 | 6.0 | >8.4 |
| | 1.2% | 4.9 | 6.0 | >8.4 |

| | |
|---|---|
| Listeria Suspended | Surfactant Yes |

| | | | | |
|---|---|---|---|---|
| LA (%) | 0.6% | 6.3 | 7.7 | >9.0 |
| | 0.9% | 7.7 | 7.5 | >9.0 |
| | 1.2% | 7.6 | 8.0 | >9.0 |
| Water | Control | 0.0 | | |
| Chlorine | 64 ppm | 2.1 | | |
| CS | 0.6% | 3.2 | | |

| | Log Reductions | | |
|---|---|---|---|
| | PAA (ppm) | | |
| Concentration | 60 | 70 | 80 |

| | |
|---|---|
| E. Coli Suspended | Surfactant No |

| | | | | |
|---|---|---|---|---|
| LA (%) | 0.6% | 5.6 | 6.2 | 6.6 |
| | 0.9% | 6.1 | 7.3 | 8.7 |
| | 1.2% | 7.2 | 8.5 | >9 |

| | |
|---|---|
| Listeria Suspended | Surfactant Yes |

| | | | | |
|---|---|---|---|---|
| LA (%) | 0.6% | 5.6 | 6.6 | 6.8 |
| | 0.9% | 6.2 | 8.4 | >9 |
| | 1.2% | 8.4 | 9.1 | >9 |
| Water | Control | 0.0 | | |
| Chlorine | 64 ppm | 3.7 | | |
| CS | 0.6% | 6.1 | | |

The following tables show the results for the attached-cells challenge test:

| | |
|---|---|
| | Spinach |
| Attached | PAA (ppm) |

| E. Coli | Concenration | 0 | 60 | 70 | 80 |
|---|---|---|---|---|---|
| LA (%) | 0.0% | 0.00 | 0.69 | 1.33 | 2.46 |
| | 0.6% | 0.09 | 0.65 | 1.70 | 2.94 |
| | 0.9% | 0.42 | 1.37 | 1.92 | 3.70 |
| | 1.2% | 0.81 | 1.82 | 2.37 | 4.17 |
| Chlorine | 64 ppm | 1.35 | | | |
| CS | 0.6% | 1.47 | | | |

| | |
|---|---|
| | Romaine |
| Attached | PAA (ppm) |

| E. Coli | Concenration | 0 | 60 | 70 | 80 |
|---|---|---|---|---|---|
| LA (%) | 0.0% | 0.05 | 0.26 | 0.53 | 1.18 |
| | 0.6% | 0.24 | 0.47 | 0.76 | 1.68 |
| | 0.9% | 0.37 | 1.06 | 1.39 | 2.60 |
| | 1.2% | 1.28 | 1.25 | 1.64 | 4.51 |
| Chlorine | 64 ppm | 0.61 | | | |
| CS | 0.6% | 0.71 | | | |

| | |
|---|---|
| | Spinach |
| Attached | PAA (ppm) |

| Listeria | Concenration | 0 | 60 | 70 | 80 |
|---|---|---|---|---|---|
| LA (%) | 0.0% | 0.0 | 0.3 | 0.5 | 1.2 |
| | 0.6% | 0.1 | 0.3 | 1.6 | 3.0 |
| | 0.9% | 0.2 | 0.3 | 2.0 | 3.5 |
| | 1.2% | 0.2 | 0.7 | 3.9 | 3.9 |
| Chlorine | 64 ppm | 0.4 | | | |
| CS | 0.6% | 0.5 | | | |

| | |
|---|---|
| | Romaine |
| Attached | PAA (ppm) |

| Listeria | Concenration | 0 | 60 | 70 | 80 |
|---|---|---|---|---|---|
| LA (%) | 0.0% | 0.0 | 0.6 | 1.0 | 1.7 |
| | 0.6% | 1.1 | 0.9 | 2.3 | 4.1 |
| | 0.9% | 1.4 | 1.6 | 3.2 | 4.5 |
| | 1.2% | 1.5 | 2.2 | 4.1 | 4.8 |
| Chlorine | 64 ppm | 1.0 | | | |
| CS | 0.6% | 1.2 | | | |

The above results accord with a surprisingly effective and striking increase in the removal of microorganisms and improvement of product shelf-life associated due to use of an aqueous solution according to the invention.

### Example 2

The next example demonstrates that the presence of a 2-hydroxy organic acid (e.g., lactic acid) greatly reduces the consumption of peroxyacetic acid during the treatment of produce and illustrates the use of an aqueous sanitizing solution according to the invention. As shown below, the solutions according to the invention advantageously conserve peroxyacetic acid during the removal of microorganisms from the surface of a variety of produce. The methods and compositions of the invention are also shown to greatly improve the shelf-life of the produce and greatly retard produce decay. The savings should extend to such diverse microorganisms as bacteria, yeast, and mold.

Synergism with Respect to Efficacy in a Suspended Cells Challenge Test at 20 s Residence Time with No Surfactant.

The experimental treatment groups were tap water, chlorinated water, a FE sanitizer wash water (FE, FE sanitizer, a solution of peroxyacetic acid and lactic acid, as further specified in a given experiment). The experimental parameters were 40 to 45° F.; the residence time was 20 s; the pH:
water (˜7)
chlorinated water (6.5 to 7.1)
lactic acid (3.8 to 4.0)
peroxyacetic acid (6.5 to 6.8)
FE sanitizer wash water (2.7 to 3.2)
   The microbial surrogates were Listeria innocua or E. coli K-12 with a streptomycin resistance gene.

The experimental protocol was as follows:
1. Transfer 1.00 mL of a ˜10⁸ cfu/g Lactobacillus plantarum (ATCC 14917) stock culture into a test tube containing 9.00 mL of treatment test solution
2. Vortex the mixture for 15 s
3. Stop the reaction by transferring 1 mL of the treated samples to 9 mL of Butterfield Phosphate Buffer
4. Enumerate viable residual cells through serial dilutions and spread plating with 1-mL transfers
5. Ensure that the operating temperature is kept at 40 to 45° F. (only one test tube is removed out of the fridge at a time as the kinetics of chemicals change significantly if the whole test is run at room temperature)
6. Repeat Steps 1 to 5 two more times
7. Repeat Steps 1 to 6 with flume water
8. Repeat Steps 1 to 6 with chlorinated water
9. Repeat Steps 1 to 8 with various levels of FE
10. Repeat Steps 1 to 8 with various levels of lactic acid
11. Repeat Steps 1 to 8 with various levels of peroxyacetic acid
12. Repeat Steps 1 to 11 with Listeria innocua (ATCC33090)

### Estimation of Log Reductions

1. Log activation is a measure of the percent of microorganisms that are inactivated during the disinfection process and is defined as Log Inactivation=Log₁₀ (Nₒ/N_{T}) where Nₒ is the initial influent concentration of viable microorganisms; N_{T} is the concentration of surviving microorganisms. As M cfu/g=microbial population of stock culture; W cfu/g=microbial population in solution of “Water Treatment” and X cfu/g=microbial population in solution of “X Treatment,” the Log reduction caused by “Treatment X”=Log(w/x)

### Results and Conclusions

TABLE 2.1
Comparison of log reduction of suspended Listeria innocua
cells by chlorinated wash water, lactic acid wash water,
peroxyacetic acid wash water, and FE sanitizer wash water
Listeria innocua ATCC 33090 20 s Residence time

| Lactic | Peroxyacetic acid (ppm) | | | |
|---|---|---|---|---|
| Acid (ppm) | 0 | 70 | 75 | 80 |
| 0 | | 1.40 | 1.70 | 1.80 |
| 2000 | 0.08 | 3.11 | 4.09 | 5.15 |
| 2500 | 0.19 | 3.22 | 5.03 | 5.36 |
| 3000 | 0.05 | 3.49 | 5.04 | 7.15 |

| | |
|---|---|
| Chlorinated Water, ~15.5 ppm, ~pH 7 | 0.06 |

TABLE 2.2
Comparison of log reduction of suspended Lactobacillus plantarum
cells by chlorinated wash water, lactic acid (LA) wash water,
peroxyacetic acid (PA) wash water, and FE sanitizer wash water.
Lactobacillus plantarum 14917 20 s Residence time

| Lactic | Peroxyacetic acid (ppm) | | | |
|---|---|---|---|---|
| Acid (ppm) | 0 | 70 | 75 | 80 |
| 0 | | 4.52 | 5.59 | 5.59 |
| 2000 | 0.00 | 7.09 | >7.74 | >7.74 |
| 2500 | 0.02 | 7.09 | >7.74 | >7.74 |
| 3000 | 0.01 | >7.74 | >7.74 | >7.74 |

| | |
|---|---|
| Chlorinated Water, ~15.5 ppm, ~pH 7 | 0.00 |

Log reduction of the test FE sanitizer (here, a combination of lactic acid and peroxyacetic acid as specified above) on L. innocua and L. plantarum was significantly better than PA wash water and LA wash water. This clearly indicated the synergistic effects of combining LA and PA. FE sanitizer wash water with 70 ppm PA and 2000 ppm LA at 20 s residence time provided ˜3-log₁₀ reduction on Listeria innocua. The log reduction of provided by the combination of lactic acid and peroxyacetic acid) was about significantly 2 to 4 folds better than peroxyacetic acid with no lactic acid addition.

### Example 3

The next experiments compares the effects of sanitizers on vegetative pathogens suspended in a liquid.

### Processing Parameters and Treatments

Treatments: tap water, chlorinated water, FE sanitizer wash water;

Temperature: 40 to 45° F.; Residence time: 30 s

pH:
water (˜7)
chlorinated water (6.5 to 7.1)
FE sanitizer wash water (2.7 to 3.2)

Pathogens:
5-strains cocktail of E. coli O157:H7 (F4546, F4637, SEA13B88, TW14359, 960218)
5-strains cocktail of Listeria monocytogenes (ATCC 19115, ATCC51414, ATCC15313, FRR B2472 (SCOTT A), 1838)
5-strains cocktail of Salmonella (S. Newport, S. Tennessee, S. muenchen, S. cubana, S. St. Paul)

### Activation of Stock Culture

1. Activation of stock culture is attained via a series of transfers of stock culture to optimum growth medium aseptically in a biological safety cabinet
2. Retrieve a small loop (˜100 uL) of pure culture from the stock culture in storage and transfer it into a test tube containing 10 mL of optimum growth medium broth specific for each microorganism as recommended by American Type Culture Collection (ATCC) or published articles
3. Incubate culture till it reaches end of log growth phase at its optimum growth temperature as recommended by ATCC or published articles
4. Verify purity of the transferred culture by streak plating and spread plating
5. Retrieve 1.5-ml of culture broth from Step 3 and transfer it into a 250-mL Erlenmeyer Flask containing 150-mL optimum growth medium broth specific for each microorganism as recommended by American Type Culture Collection (ATCC) or published articles
6. Incubate culture till it reaches end of log growth phase at its optimum growth temperature as recommended by ATCC or published articles
7. Verify purity of the transferred culture by streak plating
8. Enumerate the concentration of the culture broth from Step 6 by spread plating and serial dilution at 1-mL transfers
9. Cool down the 150-mL Erlenmeyer Flask stock culture at refrigeration temperature for 1 to 4 h prior to inoculation

### Innoculum Preparation and Enumeration

1. Separate the 150-mL of cooled-down stock culture in the 2^{nd} transfer Erlenmeyer flask into three 50-mL centrifuge tubes at equal volume (50 mL each)
2. Centrifuge the tubes at 10,000 RPM for 15 minutes at 4° C.
3. Decant the liquid broth from each centrifuge tube leaving behind the pellet of cells
4. Fill the centrifuge tube from Step 3 with 5-mL of sterile 0.1% peptone water and vortex to loosen and mix the pellet of cells
5. Pour all the re-suspended stock culture into one centrifuge tube to form a ˜10⁸ cfu/gm of innoculum
   Enumerate and confirm the microbial population of the innoculum obtained from Step ‘5’ by spread plating via serial dilutions with 1-mL transfers

### Methods

6. Transfer 1.00 mL of a ˜10⁸ cfu/g E. coli O157:H7 5-strains cocktail stock culture into a test tube containing 9.00 mL of test solution
7. Vortex the mixture for 15 s
8. Stop the reaction by transferring 1 mL of the treated samples to 9 mL of Butterfield Phosphate Buffer
9. Enumerate viable residual cells through serial dilutions and spread plating with 1-mL transfers
10. Ensure that the operating temperature is kept at 40 to 45° F. (only one test tube is removed out of the fridge at a time as the kinetics of chemicals change significantly if the whole test is run at room temperature)
11. Repeat Steps 1 to 5 two more times
12. Repeat Steps 1 to 6 with flume water
13. Repeat Steps 1 to 6 with chlorinated water (10 ppm active chlorine at pH 6.5 to 7)
14. Repeat Steps 1 to 8 with another level of FE
15. Repeat Steps 1 to 8 with another 5-strains cocktail of Listeria monocytogenes
16. Repeat Steps 1 to 8 with another 5-strains cocktail of Salmonella

### Results and Conclusion

TABLE 3.1
Comparison of Log reduction of suspended E. coli O157:H7 cells
by chlorinated wash water and the test FE sanitizers wash waters.

| | Microbial | |
|---|---|---|
| | population | Log |
| 5-Strains cocktail of E. coli O157:H7 | (log cfu/mL) | Reduction |
| Residence time | 30 s | |
| Test Date | Jan. 21, 2009 | |
| Temperature | 40 to 45 F. | |
| Inoculum microbial population | 9.0 | |
| Tap Water | 8.0 | |
| (9 mL water with 1 mL of inoculum) | | |
| Chlorinated Water, 10 ppm at pH 7.1 (9 mL | 7.0 | 0.9 |
| chlorinated water with 1 mL of inoculum) | | |
| FE1- PA: 68 ppm, LA; 4600 ppm, pH 2.8 to 3 | <1.0 | >7 |
| (9 mL FE sanitizer with 1 mL of inoculum) | No residual | |
| | cells at 10¹ | |
| FE2- PA: 71 ppm, LA 5100 ppm, pH 2.8 to 3 | <1.0 | >7 |
| (9 mL FE sanitizer with 1 mL of inoculum) | No residual | |
| | cells at 10¹ | |

TABLE 3.2
Comparison of Log reduction of suspended Salmonella cells by
chlorinated wash water and the test FE sanitizers wash water.

| | Microbial | Log |
|---|---|---|
| | population | Reduc- |
| 5-Strains cocktail of Salmonella | (log cfu/mL) | tion |
| Residence time | 30 s | |
| Test Date | Jan. 21, 2009 | |
| Temperature | 40 to 45 F. | |
| Inoculum microbial population | 8.9 | |
| Tap Water | 8.0 | |
| (9 mL water with 1 mL of inoculum) | | |
| Chlorinated Water, 10 ppm at pH 7.1 | 7.0 | 1.0 |
| (9 mL chorinated water with 1 mL of inoculum) | | |
| FE1- PA: 68 ppm, LA; 4600 ppm, pH 2.8 to 3 | <1.0 | >7 |
| (9 mL FE sanitizer with 1 mL of inoculum) | No residual | |
| | cells at 10¹ | |
| FE2- PA: 71 ppm, LA 5100 ppm, pH 2.8 to 3 | <1.0 | >7 |
| (9 mL FE sanitizer with 1 mL of inoculum) | No residual | |
| | cells at 10¹ | |

TABLE 3.3
Comparison of Log reduction of suspended Listeria monocytogenes
cells by chlorinated wash water and the test
FE sanitizers wash water.

| | Microbial | Log |
|---|---|---|
| | population | Reduc- |
| 5-Strains cocktail of Listeria moncytogenes | (log cfu/mL) | tion |
| Residence time | 30 s | |
| Test Date | Jan. 21, 2009 | |
| Temperature | 40 to 45 F. | |
| Inoculum microbial population | 7.1 | |
| Tap Water | 6.2 | |
| (9 mL water with 1 mL of inoculum) | | |
| Chlorinated Water, 10 ppm at pH 7.1 | 5.0 | 1.2 |
| (9 mL chorinated water with 1 mL of inoculum) | | |
| FE1- PA: 68 ppm, LA; 4600 ppm, pH 2.8 to 3 | No residual | >5.2 |
| (9 mL FE sanitizer with 1 mL of inoculum) | cells at 10¹ | |
| FE2- PA: 71 ppm, LA 5100 ppm, pH 2.8 to 3 | No residual | >5.2 |
| (9 mL FE sanitizer with 1 mL of inoculum) | cells at 10¹ | |

10 ppm chlorinated water reduced the populations of each pathogen by ˜1-log₁₀ when compared to the tap water control. The two concentrations of FE sanitizer wash water plate counts had no residual colonies and the results were recorded as <1.0 log₁₀ cfu/mL. Hence FE sanitizer wash water delivered reductions of greater than 7-log₁₀ for E. coli O157:H7 and Salmonella, and greater than 5.2-log₁₀ for Listeria monocytogenes when compared to the tap water control. The lower reduction observed in Listeria monocytogenes does not indicate that the FE sanitizer was less effective against that pathogen as the reported results were restricted by the original population of the stock inoculum.

### Example 4

The purpose of these experiments was to determine the antimicrobial activity of sanitizers on vegetative pathogens that are attached on the surface of leaves

### Processing Parameters and Treatments

Treatments: tap water, chlorinated water, test FE sanitizer wash water;
Temperature: 40 to 45° F.; Residence time: 30 s;
pH:
water (˜7)
chlorinated water (6.5 to 7.1)
FE sanitizer wash water (2.7 to 3.2)
   Products tested: diced Romaine leaves and matured spinach leaves

### Pathogens:

5-strains cocktail of E. coli O157:H7 (F4546, F4637, SEA13B88, TW14359, 960218)
5-strains cocktail of Listeria monocytogenes (ATCC 19115, ATCC51414, ATCC15313, FRR B2472 (SCOTT A), 1838)
5-strains cocktail of Salmonella (S. Newport, S. Tennessee, S. muenchen, S. cubana, S. St. Paul)
   Activation of stock culture
1. Activation of stock culture is attained via a series of transfers of stock culture to optimum growth medium aseptically in a biological safety cabinet.
2. Retrieve a small loop (˜100 uL) of pure culture from the stock culture in storage and transfer it into a test tube containing 10 mL of optimum growth medium broth specific for each microorganism as recommended by American Type Culture Collection (ATCC) or published articles.
3. Incubate culture till it reaches end of log growth phase at its optimum growth temperature as recommended by ATCC or published articles.
4. Verify purity of the transferred culture by streak plating and spread plating.
5. Retrieve 1.5-ml of culture broth from Step 3 and transfer it into a 250-mL Erlenmeyer Flask containing 150-mL optimum growth medium broth specific for each microorganism as recommended by American Type Culture Collection (ATCC) or published articles
6. Incubate culture till it reaches end of log growth phase at its optimum growth temperature as recommended by ATCC or published articles.
7. Verify purity of the transferred culture by streak plating.
8. Enumerate the concentration of the culture broth from Step 6 by spread plating and serial dilution at 1-mL transfers.
9. Cool down the 150-mL Erlenmeyer Flask stock culture at refrigeration temperature for 1 to 4 h prior to inoculation.

### Innoculum Preparation and Enumeration

1. Separate the 150-mL of cooled-down stock culture in the 2nd transfer Erlenmeyer flask into three 50-mL centrifuge tubes at equal volume (50 mL each).
2. Centrifuge the tubes at 10,000 RPM for 15 minutes at 4° C.
3. Decant the liquid broth from each centrifuge tube leaving behind the pellet of cells
4. Fill the centrifuge tube from Step 3 with 5-mL of sterile 5% Horse Serum solution and vortex to loosen and mix the pellet of cells.
5. Pour all the re-suspended stock culture into one centrifuge tube to form a ˜108 cfu/gm of innoculum.
6. Enumerate and confirm the microbial population of the innoculum obtained from Step ‘5’ by spread plating via serial dilutions with 1-mL transfers

### Samples Preparation

1. Take 4 leaves of the tested produce and place them into a 6″×6″×5″ sterile polypropylene (PP) basket. If the tested produce is Romaine, cut the Romaine into 1.5″×2.5″ rectangles
2. Of the four leaves in Step 1, two should have their upper epidermis facing upward and two should have their lower epidermis facing upward
3. Retrieve 50 uL of the ˜10⁸ cfu/g stock culture with a 100 uL pipette and slowly spike each leaf by dropping small size droplets (10 to 15 droplets) of the inoculum onto the leaf flat surface and midrib that are facing upward. Be sure to remove excess stock on sides of pipette tip before spiking leaves. Be careful not to shake the PP basket and causes the droplets to fall out of the leaves prior to drying.
4. Arrange the baskets with the spiked leaves in a biological safety cabinet with Drierite as shown in Photo 1 for 1-1.5 hrs at 70-80 F and 38 to 48% relative humidity. Ensure that the hood temperature is steady (<±2 F) throughout the drying process.
5. Ensure that the leaves are not in wilted condition at the end of the drying period.

### Treatment of Spiked Leaves

Transfer 3 L of Test Solution from the PP Carboy into the 5-L Sterile PP Tub
1. Add the required volume of the final ingredient into the 3 L solution and mix thoroughly with a sterilized tong if needed
2. Transfer two spiked leaves (1 spiked on the upper epidermis and the other spiked on the lower epidermis) into an empty sterile PP basket
3. Place the PP basket with spiked leaves into a sterile container containing 3 L of the completed formulation of the test solution
4. Maintain the temperature of the test solution at 40-45° F.
5. Use a tong to gently pushed the leaves into the test solution to ensure total submersion of the leaves at all times and to prevent folding and overlapping of leaves
6. Start stop watch for timing the 30 s once the leaves are totally submerged
7. Take treated leaves from the basket and place them into a stomacher bag by means of a sterile tong
8. Label the stomacher bag with the associated treatment for the leaves
9. Smashed the leaves into pieces by means of a sanitized rubber melon hammer
10. Repeat Step 1 to 7 with the other treatments of the test
11. Each treatment must be done in triplicates following the sequence of Step 13
12. Each replicate must be performed separately to avoid error from bacterial death during the drying process. The order of testing is as followed:
   a. 1^{st} Replication: 1 sample of control with no spike, control with spiked bacteria, spiked bacteria with water wash, spiked bacteria with chlorinated water wash, spiked bacteria with FE1 wash, and spiked bacteria with FE2 wash.
   b. 2^{nd} Replication: 1 sample of control with no spike, control with spiked bacteria, spiked bacteria with water wash, spiked bacteria with chlorinated water wash, spiked bacteria with FE1 wash, and spiked bacteria with FE2 wash.
   c. 3^{rd} Replication: 1 sample of control with no spike, control with spiked bacteria, spiked bacteria with water wash, spiked bacteria with chlorinated water wash, spiked bacteria with FE1 wash, and spiked bacteria with FE2 wash.
13. Enumeration of samples must be performed immediately after each replication

### Enumeration of Treated Leaves

1. Add 100 mL phosphate buffer into a stomacher bag with the treated mashed leaves until a 100-fold dilution is attained
2. Stomach the bag with phosphate buffer and treated leaves for 30 s
3. Shake the leaves back into the phosphate buffer solution and repeat the stomaching for another 30 seconds
4. Remove buffer from stomached sample and enumerate for residual cells by serial dilution and spread plating with 1-mL transfers
5. Repeat Step 1 to 4 for all other treatments

### Estimation of Log Reductions

M cfu/g=microbial population on leaves without any treatment;
R cfu/g=microbial population in water solution for the “Water Treatment”;
W cfu/g=microbial population on leaves from “Water Treatment”;
X cfu/g=microbial population on leaves from “X Treatment”;
   Hence, Log reduction caused by “Treatment X”=Log(w/x)
Microorganisms removed due to mechanical washing=R
Microorganisms died during the drying process=M−W−R

### Results

TABLE 4.1
Log reduction of pathogens attached on spinach and Romaine lettuce
(average of 3 replicates) by tap water at 40 to 45° F.

| | Tap Water Wash |
|---|---|
| E. coli O157:H7 on Spinach | 0.8 |
| E. coli O157:H7 on Romaine | 1.5 |
| Salmonella on Spinach | 0.9 |
| Salmonella on Romaine | 0.3 |
| L. monocytogenes on Spinach | 1.4 |
| L. monocytogenes on Romaine | 1.4 |

The tap water wash removed 0.3 to 1.5 log₁₀ of inoculated cells from the leaves indicating that complete attachment of cells on the leaves was not achieved. This was probably caused by the desiccation and wilting of the leaves under low relative humidity of the environment (20 to 23% rather than 38 to 48% as listed in the protocol).

TABLE 4.2
Additional log reduction of pathogens attached on spinach
and Romaine lettuce (average of 3 replicates) by chlorinated
wash water when compared with tap water wash

| | Chorinated water wash | | |
|---|---|---|---|
| | water at 40-45 F. | | |
| | | Concentration | Log |
| | pH | ppm | Reduction |
| E. coli O157:H7 on Spinach | 7.1 | 9.7 | 2.3 |
| E. coli O157:H7 on Romaine | 7.0 | 9.7 | 1.4 |
| Salmonella on Spinach | 6.9 | 9.3 | 1.2 |
| Salmonella on Romaine | 6.9 | 9.7 | 0.8 |
| L. monocytogenes on Spinach | 6.9 | 9.3 | 0.1 |
| L. monocytogenes on Romaine | 6.9 | 9.0 | 0.4 |

The 10 ppm chlorinated water provided an additional reduction of 0.1-log₁₀ to 1.4-log₁₀ on the pathogens. The 2.3-log₁₀ in the case of spinach was exceptionally high when compared with surrogate attached cells results and was probably caused by the incomplete attachment of the cells on the leaves as shown by the tap water wash results.

TABLE 4.3
Additional log reduction of pathogens attached on
spinach and Romaine lettuce (average of 3 replicates)
by FE sanitizer wash water at 40 to 45 F.

| | FE sanitizer wash | | |
|---|---|---|---|
| | water at 40-45 F. | | |
| | Peroxyacetic | | |
| | acid conc. | Lactic acid | Log Re- |
| | (ppm) | conc (ppm) | duction |
| E. coli O157:H7 on Spinach | 68 | 4846 | 2.9 |
| E. coli O157:H7 on Romaine | 67 | 4800 | 2.6 |
| Salmonella on Spinach | 66 | 4833 | 2.3 |
| Salmonella on Romaine | 69 | 4758 | 2.1 |
| L. monocytogenes on Spinach | 70 | 4782 | 2.2 |
| L. monocytogenes on Romaine | 71 | 4769 | 3.4 |

The test FE sanitizer wash water (69 ppm peroxyacetic acid and 4800 ppm lactic acid) provided an additional reduction of 2.1-logᵢₙ to 3.4-log₁₀ on the pathogens when compared with tap water wash.

When compared to chlorinated water, the FE sanitizer provided an additional 2-log₁₀ reduction of pathogens that were attached on leaves. In addition, storing the spread plates at 40 F indicated that injured cells were not able to grow at refrigerated temperatures within a week. If the bacterial cells were not able to grown on nutrient rich agar plates, they will most likely not grow on the treated fresh produce.

### Example 5

These experiments evaluated the consumption or depletion of peroxyacetic acid when used to wash produce. The objective accordingly was to compare the amount of chopped Romaine Lettuce required to deplete 600 gallons of chlorinated wash water, 600 gallons of peroxyacetic acid wash water, and 600 gallons of FE sanitizer wash water

Processing Parameters and Treatments

Treatments: chlorinated water, peroxyacetic acid wash water, and FE sanitizer wash water

Temperature: 38 to 40° F.

Residence time: 20 s

pH:
chlorinated water (6.5 to 7.1)
peroxyacetic acid (6.5 to 6.8)
FE sanitizer wash water (2.7 to 3.2)

Produce: 1.5″×2″ diced Romaine lettuce

A. Determination of the Amount of Romaine Lettuce that could Deplete 600 Gallons of Peroxyacetic Acid Wash Water.
1. Perform full sanitization on the Pilot Line System.
2. Fill the 2^{nd} flume tank, 2^{nd} reservoir, and 2^{nd} filtering tank with tap water.
3. Recycle the water through the system until the water in the system is being cooled down to 40° F.
4. Calibrate the Prominent System and use the Prominent System to monitor the concentration of PAA in the wash water.
5. Add the PAA to the 2^{nd} filtering tank until the target processing limit is reached.
6. Dice the Romaine Lettuce via the translicer.
7. Collect the 2″×2″ diced Romaine in totes.
8. Record the weight of each tote prior to transferring it to the 2″ flume.
9. Collect three untreated bags of Romaine Lettuce from each bin (1 top, 1 middle, and 1 bottom).
10. Collect three treated bags of Romaine Lettuce at the end of F2 (1 beginning, 1 middle, and 1 end of the bin).
11. Place white totes at the bottom of the locations with water spill. Return the spilt water back into the flume tank as needed.
12. Place white totes at the bottom outlets of the centrifuge to collect liquid that would be spin off from the leaves. Return the collected water back into the flume tank as needed.
13. Repeat Steps ‘e’ to ‘k’ for the rest of the bins till the FE concentrations fall below the lowest processing limits.
14. Enumerate the microbial population (APC and Yeast and mold) on the collected samples.

B. Determination of the Amount of Romaine Lettuce that could Deplete 600 Gallons of FE Wash Water
1. Perform full sanitization on the Pilot Line System.
2. Fill the 1^{st} flume tank, 2^{nd} flume tank, 1^{st} reservoir, 2^{nd} reservoir, 1^{st} filtering tank, and 2nd filtering tank with tap water.
3. Recycle the water through the system until the water in the system is being cooled down to 40° F.
4. Switch on the by-passes for the 1^{st} and 2^{nd} flume tank systems so that water would not be going through the filtering systems but only recycling from the flume tank to its associate reservoir continuously.
5. Add the chemical ingredients to both tank until the target processing limit is reached.
6. Verify the concentration of FE by the probe of the Prominent Monitoring System at the 1^{st} flume tank (F1), 1^{st} Reservoir (R1), 2″ Flume tank (F2), and the 2″ Reservoir (R2).
7. Collect water samples from F1 and F2.
8. Assemble the Romaine Lettuce Bins next to the dumpster.
9. Transfer whole Romaine Lettuce leaves from the bin to the conveyor.
10. Ensure that the lid above the F1 is closed. Turn the “ON/OFF” switch of the translicer to “ON”.
11. Turn the conveyor for transferring leaves into the translicer to “ON”.
12. Ensure that the chopped Romaine are delivered evenly into the flume tank without aggregation and clumping.
13. Collect three untreated bags of Romaine Lettuce from each bin (1 top, 1 middle, and 1 bottom).
14. Collect three treated bags of Romaine Lettuce at the end of F2 (1 beginning, 1 middle, and 1 end of the bin).
15. Verify the pH, temperature, and the concentration of FE at the 1^{st} flume tank (F1), 1^{st} Reservoir (R1), 2^{nd} Flume tank (F2), and the 2^{nd} Reservoir (R2) before and after processing a bin.
16. Place white totes at the bottom of the locations with water spill. Return the spilt water back into the flume tank as needed.
17. Place white totes at the bottom outlets of the centrifuge to collect liquid that would be spin off from the leaves. Return the collected water back into the flume tank as needed.
18. Repeat Steps ‘e’ to ‘o’ for the rest of the bins till the FE concentrations fall below the lowest processing limits.
19. Enumerate the microbial population (APC and Yeast and mold) on the collected samples.

C. Determination of the Amount of Romaine Lettuce that could Deplete 600 Gallons of Chlorinated Water to Concentration Below the Optimum
1. Perform full sanitization on the Pilot Line System.
2. Fill the 1^{st} flume tank, 2^{nd} flume tank, 1^{st} reservoir, 2^{nd} reservoir, 1^{st} filtering tank, and 2^{nd} filtering tank with tap water.
3. Recycle the water through the system until the water in the system is being cooled down to 40° F.
4. Switch on the by-passes for the 1^{st} and 2^{nd} flume tank systems so that water would not be going through the filtering systems but only recycling from the flume tank to its associate reservoir continuously.
5. Add the chemical ingredients to both tank until the target processing limit is reached
6. Verify the concentration of chlorinated water by the probe of the HACH System at the 1^{st} flume tank (F1), 1^{st} Reservoir (R1), 2^{nd} Flume tank (F2), and the 2^{nd} Reservoir (R2)
7. Collect water samples from F1 and F2.
8. Assemble the Romaine Lettuce Bins next to the dumpster.
9. Transfer Romaine Lettuce leaves from the bin to the conveyor.
10. Ensure that the lid above the F1 is closed. Turn the “ON/OFF” switch of the translicer to “ON”.
11. Turn the conveyor for transferring leaves into the translicer to “ON”.
12. Ensure that the chopped Romaine are delivered evenly into the flume tank without aggregation and clumping.
13. Collect three untreated bags of Romaine Lettuce from each bin (1 top, 1 middle, and 1 bottom).
14. Collect three treated bags of Romaine Lettuce at the end of F2 (1 beginning, 1 middle, and 1 end of the bin).
15. Verify the pH, temperature, and the concentration of chlorinated water at the 1^{st} flume tank (F1), 1^{st} Reservoir (R1), 2^{nd} Flume tank (F2), and the 2^{nd} Reservoir (R2) before and after processing a bin.
16. Place white totes at the bottom of the locations with water spill. Return the spilt water back into the flume tank as needed.
17. Place white totes at the bottom outlets of the centrifuge to collect liquid that would be spin off from the leaves. Return the collected water back into the flume tank as needed.
18. Enumerate the microbial population (APC and Yeast and mold) on the collected samples.

### Results and Conclusions

TABLE 5.1
Depletion of Peroxyacetic acid/PA with no Lactic acid/LA in the
presence of organic matter based on commercial scale test.

| | |
|---|---|
| Product: | Diced Romaine Lettuce |
| Volume of sanitizer | 600 gallons |
| Wash water Temp | 38 to 40 F. |

| Wt. of Diced | Cumulative Wt. of | | | |
|---|---|---|---|---|
| Romaine | Diced Romaine | PA | LA | Peroxide |
| added (lb) | added (lb) | (ppm) | (ppm) | (ppm) |
| 0.0 | 0.0 | 84.8 | 0 | 7.5 |
| 55.2 | 55.2 | 83.3 | 0 | 7.4 |
| 59.7 | 114.9 | 82.7 | 0 | 7.4 |
| 42.3 | 157.2 | 82.4 | 0 | 7.4 |
| 50.6 | 207.7 | 82.0 | 0 | 7.4 |
| 65.2 | 272.9 | 81.4 | 0 | 7.3 |
| 52.9 | 325.8 | 81.0 | 0 | 7.3 |
| 45.5 | 371.3 | 80.5 | 0 | 7.1 |
| 53.4 | 424.7 | 79.6 | 0 | 6.9 |
| 78.0 | 502.6 | 78.7 | 0 | 6.9 |
| 62.3 | 565.0 | 78.4 | 0 | 6.9 |
| 64.0 | 629.0 | 77.7 | 0 | 6.4 |
| 68.1 | 697.1 | 76.1 | 0 | 6.4 |
| 65.6 | 762.7 | 75.4 | 0 | 6.1 |
| 63.9 | 826.6 | 74.7 | 0 | 6.0 |
| 69.5 | 896.2 | 73.7 | 0 | 6.0 |
| 53.7 | 949.9 | 73.1 | 0 | 6.0 |

Amount of PA consumed 11.7 ppm
Pounds of PA consumed 0.012078 lb
Pounds of Romaine treated 949.90 lb
Depletion of PA 0.000013 lb of PA per lb of Romaine

TABLE 5.2
Reduction of indigenous microorganisms by peroxyacetic acid with
no Lactic acid wash water based on commercial scale test.

| | Aerobic Plate Counts |
|---|---|
| | Log cfu/g |
| Untreated | 3.4 |
| PA Wash Water | 2.7 |
| Log Reduction | 0.7 |

TABLE 5.3
Depletion of test FE sanitizer wash water (Peroxyacetic
acid/PA/PAA with Lactic acid/LA)) in the presence of
organic matter based on commercial scale test.

| | |
|---|---|
| Product: | Diced Romaine Lettuce |
| Volume of sanitizer | 600 gallons |
| Wash water Temp | 38 to 40 F. |

| Wt. of Diced | Cumulative Wt. of | | | |
|---|---|---|---|---|
| Romaine | Diced Romaine | PA | LA | Peroxide |
| added (lb) | added (lb) | (ppm) | (ppm) | (ppm) |
| 0.0 | 0.0 | 84.8 | 0 | 7.5 |
| 55.2 | 55.2 | 83.3 | 0 | 7.4 |
| 59.7 | 114.9 | 82.7 | 0 | 7.4 |
| 42.3 | 157.2 | 82.4 | 0 | 7.4 |
| 50.6 | 207.7 | 82.0 | 0 | 7.4 |
| 65.2 | 272.9 | 81.4 | 0 | 7.3 |
| 52.9 | 325.8 | 81.0 | 0 | 7.3 |
| 45.5 | 371.3 | 80.5 | 0 | 7.1 |
| 53.4 | 424.7 | 79.6 | 0 | 6.9 |
| 78.0 | 502.6 | 78.7 | 0 | 6.9 |
| 62.3 | 565.0 | 78.4 | 0 | 6.9 |
| 64.0 | 629.0 | 77.7 | 0 | 6.4 |
| 68.1 | 697.1 | 76.1 | 0 | 6.4 |
| 65.6 | 762.7 | 75.4 | 0 | 6.1 |
| 63.9 | 826.6 | 74.7 | 0 | 6.0 |
| 69.5 | 896.2 | 73.7 | 0 | 6.0 |
| 53.7 | 949.9 | 73.1 | 0 | 6.0 |

Amount of PAA consumed 10.7 ppm
Pounds of PAA consumed 0.011 lb
Pounds of Romaine treated 4011 lb
Depletion of PAA 0.0000028 lb of PAA per lb of Romaine

TABLE 5.4
Reduction of indigenous microorganisms by FE
sanitizer wash water (Peroxyacetic acid with
Lactic acid) based on commercial scale test.

| | Aerobic Plate Counts |
|---|---|
| | Log cfu/g |
| Untreated | 5.1 |
| FE Wash Water | 2.5 |
| Log Reduction | 2.6 |

TABLE 5.5
Depletion of 10 ppm chlorinated wash water in the presence
of organic matter based on commercial scale test.

| | |
|---|---|
| Product: | Diced Romaine Lettuce |
| Volume of sanitizer | 600 gallons |
| Wash water Temp | 38 to 40 F. |

| Wt. of Diced Romaine | Cumulative Wt. of Diced | | Free |
|---|---|---|---|
| added (lb) | Romaine added (lb) | pH | Chlorine ppm |
| 0 | 0.0 | 7.1 | 7.6 |
| 286.5 | 286.5 | 7.8 | 1.2 |

Amount of free chlorine consumed 6.4 ppm
Pounds of free chlorine consumed 0.006594 lb
Pounds of Romaine treated 287 lb
Depletion of free chlorine 0.000023 lb of free chlorine per lb of Romaine

TABLE 5.6
Reduction of indigenous microorganisms by chlorinated
wash water based on commercial scale test.

| | Aerobic Plate Counts |
|---|---|
| | Log cfu/g |
| Untreated | 5.1 |
| Chlorinated Water | 3.9 |
| Log Reduction | 1.2 |

The depletion of peroxyacetic acid in the FE sanitizer was 5-fold (500%) less than that of the peroxyacetic acid solution with no addition lactic acid. This shows that under the same volume and concentration of peroxyacetic acid, the tested FE sanitizer could disinfect 5 times more produce than the peroxyacetic acid sanitizer with no lactic acid addition. In addition the lbs of free chlorine required to treat a pound of Romaine was 8.5 folds (850%) more than that of the tested FE sanitizer thus indicating that per pound of the tested FE sanitizer could disinfect 8.5 times more produce than per pound of chlorinated water.

The log₁₀ reduction of indigenous microorganism on the Romaine leaf for 73-84 ppm peroxyacetic acid wash water, FE sanitizer wash water (59 to 69 ppm PA and 2,389 to 2,724 ppm LA), and 1.2 to 7.6 ppm free chlorine wash water was 0.7, 2.6, and 1.2-log₁₀, respectively. Although the FE sanitizer in the study was below the optimum lower limit, its log₁₀ reduction on indigenous microorganisms attached on the Romaine leaf was still 2.2 and 3.7 fold, respectively, higher than that of the chlorinated water and peroxyacectic acid wash water.

### Example 6

This Example focuses on use of the sanitizer on various surfaces.

Inoculum preparation: Pseudomonas aeruginosa (ATCC 9027) freeze dried culture was rehydrated in 10 mL of sterilized nutrient broth (NB) and mixed homogeneously. 0.1 mL of the stock solution was transferred to 10 mL of NB and incubated at 37 C for 24 h. Enrichment was streaked to confirm purity. 10 mL of the enriched stock was transferred to 1,000 mL of NB and incubated at 37 C for 24 h resulting in ˜10⁸ cfu/mL stationary phase culture stock. The stock was cooled at 4 C for 1 h. Microbial population of the stationary phase stock culture was enumerated by means of serial dilution with 9-mL Butterfield phosphate buffer tubes and spread plating on Nutrient Agar (TSA) pre-poured agar plates.

Non-food surface inoculation: The 1000 mL ˜10⁸ cfu/mL stock culture solution was homogeneously mixed by shaking and swirling the Erlenmeyer flask. The 1000 mL culture was separated into 20 centrifuge tubes (50 mL each) and centrifuged at 10,000 rpm and 4 C for 15 min. The stock culture pellet was re-suspended with 50 mL of NB. All the re-suspended cultures from the 20 centrifuge tubes were combined to form 1,000 mL ˜10⁸ cfu/mL inoculating stock culture. 15 mL of the P. aeruginosa inoculating stock together with a non-food surface coupon (2.5 cm×5 cm) were placed in a sterilized 50 mL-centrifuge tube and incubated for 24 h at 37 C. After 24 hr, the coupon was transferred to a sterile Petri dish and placed in an oven to dry for 1 hour at 35 C. The coupons were cut from stainless steel sheet, wood, glass slide, and plastic sheet.

Treatment of inoculated non-food surfaces: 1 mL of test solution was dispensed onto a 2.5 cm×2.5 cm marked area of each inoculated coupon for 60 s. A pre-wet sterilized cotton swab was dipped in 10 mL Butterfield phosphate buffer with sodium thiosulfate and swabbed the marked area on the coupon after 60 s exposure. The swabbed was then immediately placed into the 10 mL Butterfield phosphate buffer with sodium thiosulfate and mixed. One mL was immediately transferred from the aforementioned tube to a 9 mL Butterfield phosphate buffer. The total treatment time including the exposure time, the swabbing time, and the transfer time was 90 s. Each solution treatment was performed in duplications. The reduction for each solution treatment was compared to that of the city water treatment.

TABLE 6.1
Log reductions of Pseudomonas aeruginosa (ATCC
9027) attached on wood coupons by PA solution (100
and 140 ppm), LA solution (2500 and 7500 ppm), and
FR solution (2500 ppm LA + 100 ppm PA, 2500
ppm LA + 140 ppm PA, 7500 ppm LA + 100
ppm PA, and 7500 ppm LA + 140 ppm PA):

| Wood Coupon | | Peracetic acid (PA) (ppm) | | |
|---|---|---|---|---|
| 90 sec residence time | | 0 | 100 | 140 |
| Lactic Acid | 0 | | 1.0 | 0.8 |
| (LA) (ppm)) | 2,500 | 1.4 | 4.5 | 4.0 |
| | 7,500 | 3.6 | 5.3 | 6.3 |

TABLE 6.2
Log reductions of Pseudomonas aeruginosa (ATCC 9027)
attached on stainless steel coupons by PA solution (60 and
100 ppm), LA solution (1250 and 2500 ppm), and FR solution
(1250 ppm LA + 60 ppm PA, 1250 ppm LA + 100 ppm
PA, 2500 ppm LA + 60 ppm PA, and 2500 ppm LA + 100 ppm PA):

| Stainless steel coupon | | Peracetic acid (PA) (ppm) | | |
|---|---|---|---|---|
| 90 sec residence time | | 0 | 60 | 100 |
| Lactic Acid | 0 | | 1.5 | 1.4 |
| (LA) (ppm)) | 1,250 | 1.6 | 4.7 | 4.2 |
| | 2,500 | 1.9 | 5.2 | 5.2 |

TABLE 6.3
Log reductions of Pseudomonas aeruginosa (ATCC 9027)
attached on plastic coupons by PA solution (60 and 80
ppm), LA solution (2500 and 5000 ppm), and FR solution
(2500 ppm LA + 60 ppm PA, 2500 ppm LA + 80 ppm
PA, 5000 ppm LA + 60 ppm PA, and 5000 ppm LA + 80 ppm PA):

| Plastic coupon | | Peracetic acid (PA) (ppm) | | |
|---|---|---|---|---|
| 90 sec residence time | | 0 | 60 | 80 |
| Lactic Acid | 0 | | 1.2 | 0.9 |
| (LA) (ppm)) | 2,500 | 0.6 | 2.3 | 4.8 |
| | 5,000 | 1.2 | 3.1 | 4.8 |

TABLE 6.4
Log reductions of Pseudomonas aeruginosa (ATCC 9027)
attached on glass coupons by PA solution (60 and 80 ppm),
LA solution (1250 and 2500 ppm), and FR solution (1250
ppm LA + 60 ppm PA, 1250 ppm LA + 80 ppm PA,
2500 ppm LA + 60 ppm PA, and 2500 ppm LA + 80 ppm PA):

| Glass Coupon | | Peracetic acid (PA) (ppm) | | |
|---|---|---|---|---|
| 90 sec residence time | | 0 | 60 | 80 |
| Lactic Acid | 0 | | 0.2 | 0.0 |
| (LA) (ppm)) | 1,250 | 0.4 | 3.3 | 3.3 |
| | 2,500 | 1.7 | 3.3 | 3.3 |

All publications, patents and patent applications cited herein, whether supra or infra, are hereby incorporated by reference in their entirety to the same extent as if each individual publication, patent or patent application was specifically and individually indicated to be incorporated by reference.

1. A method of sanitizing a non-food article item, comprising contacting the surface of the article with an aqueous solution which comprises:
i) an organic peracid of the formula RC(O)OOH wherein R is methyl, ethyl, n-propyl, or s-propyl;
ii) a 2-hydroxy organic acid selected from tartaric acid, citric acid, malic acid, mandelic acid, and lactic acid;
wherein the aqueous solution has a pH from 2.5 to 6.0, inclusive and the concentration of peracid is from 40 to 250 ppm (w/w) inclusive, and the concentration of the 2-hydroxy organic acid is from 0.1 to 1% (w/w), inclusive.

2. The method of claim 1, wherein the composition further comprises iii) an anionic surfactant.

3. The method of claim 1, wherein the peracid is peroxyacetic acid and the 2-hydroxy organic acid is L-(+)-lactic acid.

4. The method of claim 3, wherein the concentration of the peroxyacetic acid in the composition is from 50 to 100 ppm (w/w), the concentration of the lactic acid in the composition is from 0.1% to 0.6% (w/w).

5. The method of claim 3, wherein concentration of peroxyacetic acid in the composition is from 60 to 80 ppm (w/w), the concentration of lactic acid in the composition is from 0.1% to 0.4% (w/w).

6. The method of claim 3, wherein the pH is between 2.5 and 4.5.

7. The method of claim 1, wherein the pH is from 2.8 to 3.2.

8. The method of claim 1, wherein the pH is about 3.0.

9. The method of claim 1, wherein the composition is at a temperature of 35° F. to 45° F.

10. The method of claim 1, wherein the composition is substantially free of nonionic surfactants, cationic surfactants or anionic surfactants.

11. The method of claim 1, which is a solution, a gel, a foam, or a suspension.

12-13. (canceled)

14. The method of claim 1, wherein the contacting is for a period of time is from 10 seconds to 1 minute.

15-18. (canceled)

19. The method of claim 1, wherein the composition is at temperature selected from room temperature, ambient temperature, or from 35° F. to 85° F.

20. The method of claim 19, wherein the composition is at temperature selected from room temperature, ambient temperature, or from 35° F. to 45° F.

21-23. (canceled)

24. The method of claim 1, wherein the 2-hydroxy organic acid which is substantially free of any hydrogen peroxide and the peracid are added separately to an aqueous fluid used to transport or wash the article.

25. The method of claim 1, wherein the treatment sanitizes the item by killing or inhibiting the growth of bacteria on, or attached to, the article.

26. (canceled)

27. The method of claim 1, wherein the article is patient care equipment, or surgical and diagnostic equipment.

28. The method of claim 1, wherein the article is a medical or dental instrument.

29. The method of claim 3, wherein the article is patient care equipment, or surgical and diagnostic equipment.

30. The method of claim 3, wherein the article is a medical or dental instrument.

31. The method of claim 1, wherein the article is equipment or a tool found in the food processing environment.
